(19) United States
(12) Patent Application Publication
(10) Pub. No.: US 2026/0186281 A1
(43) Pub. Date: Jul. 2, 2026

(54) VISUAL SYSTEM

(71) Applicant: ZHEJIANG SUNNY OPTICS CO., LTD., Yuyao City (CN)

(72) Inventors: Biran CHEN, Yuyao City (CN); Xiaobin ZHANG, Yuyao City (CN); Lin HUANG, Yuyao City (CN)

(73) Assignee: ZHEJIANG SUNNY OPTICS CO., LTD., Yuyao City (CN)

(21) Appl. No.: 19/251,985

(22) Filed: Jun. 27, 2025

(30) Foreign Application Priority Data
Dec. 30, 2024 (CN) 202411978226.9

(51) Int. Cl. G02B 17/08; G02B 5/30

(52) U.S. Cl. CPC G02B 17/08; G02B 5/3025; G02B 5/3083

(57) ABSTRACT

The disclosure provides a visual system, sequentially including a first lens assembly and a second lens assembly from a first side to a second side along an optical axis, the first lens assembly includes a first lens with a positive refractive power, a reflective polarizing element, and a quarter-wave plate; the second lens assembly includes a second lens with a positive refractive power, a partially-reflective element, and a third lens, and the second lens and the third lens are cemented to each other; and the second lens assembly is able to move along the optical axis to cause the visual system to switch between a first state and a second state. A combined focal length fz of the first lens assembly and a focal length fm of the system in the first state satisfy 5.69≤fz/fm≤8.09.

### CROSS-REFERENCE TO RELATED APPLICATION

The disclosure claims the priority to Chinese Patent Application No. 202411978226.9, filed with the China National Intellectual Property Administration (CNIPA) on Dec. 30, 2024, which is hereby incorporated by reference in its entirety.

### TECHNICAL FIELD

The disclosure relates to the technical field of optical elements, and more specifically, to a visual system.

### BACKGROUND

With the continuous development of a Virtual Reality (VR) technology, mainstream solutions for visual systems for various VR devices have shifted from a Fresnel solution to a foldback (Pancake) solution. The foldback solution may significantly shorten a total length of the system, may have better display performance, may also provide functions such as diopter adjustment, and has multiple advantages. However, for the foldback solution, especially when using a plurality of lenses, reflections between the lenses also cause more problems of ghost images, stray light, etc. occurring in final images, affecting imaging quality. Furthermore, the system continuously develops in the direction of miniaturization and lightweight, and the processability of the system still needs to be improved.

### SUMMARY

Some embodiments of the disclosure provide a visual system, sequentially including a first lens assembly and a second lens assembly from a first side to a second side along an optical axis. The first lens assembly includes a first lens, a reflective polarizing element, and a quarter-wave plate, the first lens has a positive refractive power, a first side surface thereof is a convex surface and a second side surface thereof is a planar surface; the second lens assembly includes a second lens, a partially-reflective element, and a third lens, the second lens has a positive refractive power, a second side surface thereof is a convex surface; the third lens has a positive or negative refractive power, a first side surface thereof is a concave surface and a second side surface thereof is a convex surface; the second lens and the third lens are cemented to each other and form a dually cemented lens; and the second lens assembly is configured to be able to move along the optical axis to close to or far away from a display located on the second side, and to cause the visual system to switch between a first state and a second state. The visual system satisfies a conditional expression: 5.69≤fz/fm≤8.09, 1.78≤f23/(TDm+TDn)≤7.01 and 2.00≤T12m/Δf≤4.70, fz is a combined focal length of the first lens, the reflective polarizing element, and the quarter-wave plate, fm is an effective focal length of the visual system in the first state, f23 is a combined focal length of the second lens and the third lens, TDm is a distance from the first side surface of the first lens to the second side surface of the third lens on the optical axis when the visual system is in the first state, TDn is a distance from the first side surface of the first lens to the second side surface of the third lens on the optical axis when the visual system is in the second state, T12m is a distance from the second side surface of the first lens to a first side surface of the second lens on the optical axis when the visual system is in the first state, and Δf is a change in the effective focal length of the visual system switching from the first state to the second state.

In some embodiments, a center thickness CT2 of the second lens on the optical axis, a center thickness CT3 of the third lens on the optical axis, and a distance ΔL of the second lens assembly moving along the optical axis during a switching of the visual system from the first state to the second state satisfy: 3.55<(CT2+CT3)/ΔL<3.95.

In some embodiments, a radius of curvature R1 of the first side surface of the first lens and an effective focal length fn of the visual system in the second state satisfy: 3.45≤R1/fn≤4.52.

In some embodiments, a center thickness CT1 of the first lens on the optical axis, a center thickness CTR of the reflective polarizing element on the optical axis, a center thickness CTQ of the quarter-wave plate on the optical axis, and a distance T12n from the second side surface of the first lens to the first side surface of the second lens on the optical axis when the visual system is in the second state satisfy: 4.7<(CT1+CTR+CTQ)/T12n<6.65.

In some embodiments, an effective focal length f2 of the second lens, an effective focal length f3 of the third lens, and the change Δf in the effective focal length of the visual system switching from the first state to the second state satisfy: 0.38 mm≤|f2/f3|×Δf≤2.08 mm.

In some embodiments, the distance TDn from the first side surface of the first lens to the second side surface of the third lens on the optical axis when the visual system is in the second state, an effective focal length f1 of the first lens, and an Abbe number V1 of the first lens satisfy: 5.0<TDn/(f1/V1)<7.9.

In some embodiments, a distance BFLn from the second side surface of the third lens to the display on the optical axis when the visual system is in the second state and a distance T12n from the second side surface of the first lens to the first side surface of the second lens on the optical axis when the visual system is in the second state satisfy: 3.75<BFLn/T12n<6.95.

In some embodiments, a center thickness CT3 of the third lens on the optical axis and a distance BFLm from the second side surface of the third lens to the display on the optical axis when the visual system is in the first state satisfy: 1.05<CT3/BFLm<1.45.

In some embodiments, an effective focal length f2 of the second lens, a radius of curvature R4 of the second side surface of the second lens, and the distance T12m from the second side surface of the first lens to the first side surface of the second lens on the optical axis when the visual system is in the first state satisfy: −6.81 mm≤(f2/R4)×T12m≤−3.74 mm.

In some embodiments, an effective focal length f3 of the third lens, a radius of curvature R5 of the first side surface of the third lens, and a distance BFLm from the second side surface of the third lens to the display on the optical axis when the visual system is in the first state satisfy: 3.12 mm≤|f3/R5|×BFLm≤6.12 mm.

In some embodiments, an effective focal length fn of the visual system in the second state and a distance ΔL of the second lens assembly moving along the optical axis during a switching of the visual system from the first state to the second state satisfy: 7.10≤fn/ΔL≤7.58.

In some embodiments, an Entrance Pupil Diameter (EPD) of the visual system and a change Δf in the effective focal length of the visual system switching from the first state to the second state satisfy: 4.82≤EPD/Δf≤12.15.

In some embodiments, a radius of curvature R1 of the first side surface of the first lens, a radius of curvature R6 of the second side surface of the third lens, and the distance ΔL of the second lens assembly moving along the optical axis during a switching of the visual system from the first state to the second state satisfy: −4.33 mm≤(R1/R6)×ΔL≤−0.34 mm.

In some embodiments, the combined focal length f23 of the second lens and the third lens, the effective focal length fm of the visual system in the first state, and an effective focal length fn of the visual system in the second state satisfy: 1.61≤f23/(fm+fn)≤5.84.

In some embodiments, an effective focal length f3 of the third lens and the distance TDm from the first side surface of the first lens to the second side surface of the third lens on the optical axis when the visual system is in the first state satisfy: 5.90≤|f3|/TDm≤12.19.

The visual system disclosed in the disclosure includes the first lens assembly and the second lens assembly from the first side to the second side along the optical axis. The first lens assembly includes the first lens, the reflective polarizing element, and the quarter-wave plate; and the second lens assembly includes the second lens, the partially-reflective element, and the third lens. The first lens has the positive refractive power, the first side surface thereof is a convex surface and the second side surface thereof is a planar surface. The second lens has the positive refractive power, the second side surface thereof is a convex surface. The third lens has the positive or negative refractive power, the first side surface thereof is a concave surface and the second side surface thereof is a convex surface. The second lens and the third lens are cemented to each other and form a dually cemented lens. The second lens assembly is configured to be able to move along the optical axis to close to or far away from a display located on the second side, and to cause the visual system to switch between the first state and the second state. Through the rational configuration of the visual system, and when the combined focal length fz of the first lens assembly and the effective focal length fm of the visual system in the first state satisfy the conditional expression 5.69≤fz/fm≤8.09, and by controlling the combined focal length f23 of the second lens and the third lens and distances TDm and TDn from the first side surface of the first lens to the second side surface of the third lens on the optical axis when the system is in the first state and the second state respectively to satisfy the conditional expression 1.78≤f23/(TDm+TDn)≤7.01, and controlling the air gap T12m between the first lens and the second lens when the system is in the first state and the change Δf in the effective focal length of the system switching from the first state to the second state to satisfy the conditional expression 2.00≤T12m/Δf≤4.70, a total length of the system is able to be reduced while an optimal system achieves a diopter adjustment function, such that an overall processability of the system is ensured, and system stray light is able to be reduced.

### BRIEF DESCRIPTION OF THE DRAWINGS

In conjunction with the drawings, other features, objectives and advantages of the disclosure will become more apparent by the following detailed description of the non-limiting embodiments. In the drawings:

FIG. 1 shows a structural schematic diagram of a visual system in a first state (+2D state) according to Embodiment 1 of the disclosure.

FIG. 2 shows a Modulation Transfer Function (MTF) curve of a visual system in a first state (+2D state) according to Embodiment 1.

FIG. 3 shows a structural schematic diagram of a visual system in a second state (−5D state) according to Embodiment 1 of the disclosure.

FIG. 4 shows an MTF curve of a visual system in a second state (−5D state) according to Embodiment 1.

FIG. 5 shows a structural schematic diagram of a visual system in a first state (+2D state) according to Embodiment 2 of the disclosure.

FIG. 6 shows an MTF curve of a visual system in a first state (+2D state) according to Embodiment 2.

FIG. 7 shows a structural schematic diagram of a visual system in a second state (−5D state) according to Embodiment 2 of the disclosure.

FIG. 8 shows an MTF curve of a visual system in a second state (−5D state) according to Embodiment 2.

FIG. 9 shows a structural schematic diagram of a visual system in a first state (+2D state) according to Embodiment 3 of the disclosure.

FIG. 10 shows an MTF curve of a visual system in a first state (+2D state) according to Embodiment 3.

FIG. 11 shows a structural schematic diagram of a visual system in a second state (−5D state) according to Embodiment 3 of the disclosure.

FIG. 12 shows an MTF curve of a visual system in a second state (−5D state) according to Embodiment 3.

FIG. 13 shows a structural schematic diagram of a visual system in a first state (+2D state) according to Embodiment 4 of the disclosure.

FIG. 14 shows an MTF curve of a visual system in a first state (+2D state) according to Embodiment 4.

FIG. 15 shows a structural schematic diagram of a visual system in a second state (−5D state) according to Embodiment 4 of the disclosure.

FIG. 16 shows an MTF curve of a visual system in a second state (−5D state) according to Embodiment 4.

FIG. 17 shows a structural schematic diagram of a visual system in a first state (+2D state) according to Embodiment 5 of the disclosure.

FIG. 18 shows an MTF curve of a visual system in a first state (+2D state) according to Embodiment 5.

FIG. 19 shows a structural schematic diagram of a visual system in a second state (−5D state) according to Embodiment 5 of the disclosure.

FIG. 20 shows an MTF curve of a visual system in a second state (−5D state) according to Embodiment 5.

### DETAILED DESCRIPTION OF THE EMBODIMENTS

In order to better understand the disclosure, aspects of the disclosure will be described in greater detail with reference to the drawings. It is to be noted that, these detailed descriptions are merely descriptions of specific embodiments of the disclosure and are not intended to limit the scope of the disclosure in any way. Throughout the specification, the same accompanying symbols refer to the same components. The expression “and/or” includes any and all combinations of one or more of the listed items in association.

It is to be noted that, in the specification, expressions such as first, second, etc. are used only to distinguish one feature from another and do not indicate any limitation of the features. Accordingly, without departing from the teachings of the disclosure, the first lens discussed below may also be referred to as a second lens, and the second lens may also be referred to as the first lens.

In the drawings, the thickness, size and shape of the lens have been slightly exaggerated for ease of illustration. Specifically, a spherical shape or aspheric shape shown in the drawings is shown by some examples. That is, the spherical shape or the aspheric shape is not limited to the spherical shape or aspheric shape shown in the drawings. The drawings are for illustrative purposes only and are not strictly to scale.

Herein, a paraxial region refers to a region nearby an optical axis. If the surface of a lens is a convex surface and a position of the convex surface is not defined, it indicates that the lens surface is a convex surface at least in the paraxial region; and if the surface of the lens is a concave surface and a position of the concave surface is not defined, it indicates that the lens surface is a concave surface at least in the paraxial region.

It is also to be understood that, the terms “include”, “including”, “having”, “contain”, and/or “containing”, when used in this specification, indicate the presence of the stated features, elements, and/or components, but do not exclude the presence or addition of one or more other features, elements, components, and/or combinations thereof. Furthermore, when an expression such as “at least one of” appears after a list of listed features, it modifies the entire list of features, rather than individual elements of the list. Furthermore, when describing embodiments of the disclosure, “may” is used to indicate “one or more embodiments of the disclosure”. Moreover, the term “exemplary” is intended to refer to examples or illustrations.

Unless otherwise limited, all terms (including technical terms and scientific terms) used herein have the same meaning as commonly understood by those of ordinary skill in the art to which the disclosure belongs. It should also be understood that terms (e.g., terms defined in commonly used dictionaries) are to be interpreted as with a meaning consistent with their meaning in the context of the relevant technology and will not be interpreted in an idealized or overly formalized sense unless expressly so limited herein.

It is to be noted that the embodiments in the disclosure and the features in the embodiments may be combined with one another without conflict. The disclosure will be described below in detail with reference to the drawings and the embodiments.

The features, principles and other aspects of the disclosure are described in detail below.

A visual system according to an embodiment of the disclosure includes a first lens assembly and a second lens assembly. The first lens assembly includes a first lens, a reflective polarizing element, and a quarter-wave plate; and the second lens assembly includes a second lens, a partially-reflective element, and a third lens. In an embodiment, the first lens assembly and the second lens assembly are arranged in sequence from a first side to a second side along an optical axis. In an embodiment, the first lens, the reflective polarizing element, the quarter-wave plate, the second lens, the partially-reflective element, and the third lens are arranged in sequence from the first side to the second side along the optical axis.

In an embodiment, the first lens has a positive refractive power, a first side surface thereof is a convex surface, and a second side surface thereof is a planar surface.

In an embodiment, the second lens has a positive refractive power, a second side surface thereof is a convex surface.

In an embodiment, the third lens has a positive or negative refractive power, a first side surface thereof is a concave surface, and a second side surface thereof is a convex surface.

In an embodiment, the second lens and the third lens are cemented to each other and form a dually cemented lens. The cementing of the second lens and the third lens is able to reduce a total length of the system, facilitating miniaturization; a tolerance sensitivity between the lenses is able to be reduced, thereby ensuring a production yield; various aberrations are balanced, thereby improving resolution; furthermore, reflection between the lenses is also able to be reduced, thereby reducing stray light and ghost images, and facilitating improvement of relative illumination.

In an embodiment, the reflective polarizing element is arranged on or attached to the second side surface of the first lens; and the quarter-wave plate is arranged on or attached to a second side surface of the reflective polarizing element. Specifically, a first side surface of the reflective polarizing element is at least partially attached to the second side surface of the first lens; and a first side surface of the quarter-wave plate is at least partially attached to the second side surface of the reflective polarizing element.

In an embodiment, the partially-reflective element is arranged between the second lens and the third lens, and is arranged on the second side surface of the second lens or is arranged on the first side surface of the third lens. Specifically, the partially-reflective element is a transreflective film layer coated on the second side surface of the second lens or the first side surface of the third lens.

Through the rational arrangement of a structure of the visual system, a refraction and reflection of an optical path are achieved, a body length of the visual system is able to be effectively shortened, and a size and weight of the visual system are reduced, thereby achieving a lightweight of the visual system.

In an embodiment, the first side is, for example, a human eye side, and the second side is, for example, a display side. The visual system is, for example, applied to a VR device, etc.

In an embodiment, a distance of the first lens assembly including the first lens, the reflective polarizing element, and the quarter-wave plate on the optical axis relative to a display or an imaging surface of the second side of the visual system is fixed. The second lens assembly including the second lens, the partially-reflective element, and the third lens is configured to be able to move along the optical axis to close to or far away from the display or the imaging surface of the second side of the visual system, and to cause the visual system to switch between a first state and a second state. Specifically, when the second lens assembly moves to a position closest to the display or the imaging surface, a distance between the second lens assembly and the first lens assembly on the optical axis is the largest, and the visual system is in a +2D state, that is, the first state; and when the second lens assembly moves to a position farthest from the display or imaging surface, the distance between the second lens assembly and the first lens assembly on the optical axis is the smallest, and the visual system is in a −5D state, that is, the second state.

Specifically, when the visual system is in the first state, a diopter of the visual system is +2D, for example, is suitable for a user with the diopter being +2D; and when the visual system is in the second state, the diopter of the visual system is −5D, for example, is suitable for a user with the diopter being −5D. When a sign of the diopter is a negative sign, it indicates that the user belongs to myopic users; when the sign of the diopter is a positive sign, it indicates that the user belongs to hyperopic users; and a specific numerical value of the diopter indicates a refractive diopter. For example, that the diopter is +1D indicates that a hyperopic degree of the user is about 100 degrees; and that the diopter is −1D indicates that a myopic degree of the user is about 100 degrees.

It is to be noted that, in addition to the first state and the second state, the visual system according to the embodiment of the disclosure is also able to have other states between, for example, −5D and +2D. The visual system according to the embodiment of the disclosure is able to achieve continuous zooming within the range from −5D to +2D, such that requirements of users with different visions, and the users do not need to wear glasses to enjoy the VR experience.

In an embodiment, the visual system of the disclosure includes at least one diaphragm. The diaphragm is able to constrain a light path, and control light intensity. The diaphragm is arranged in an appropriate position of the visual system. For example, the diaphragm is located between the first side (e.g., a human eye side) and the first lens.

In an embodiment, Virtual Image Distances (VIDs) of the visual system in the first state and the second state are different. The VID is, for example, a distance between a virtual image formed by image light from the second side in a predetermined position and the diaphragm on the optical axis. VID=1000/diopter.

The visual system is specifically described below with reference to FIG. 1. As shown in FIG. 1, the visual system according to the embodiment of the disclosure includes a first lens assembly G1 and a second lens assembly G2, which are sequentially arranged from a first side to a second side along an optical axis. The first lens assembly G1 includes a first lens E1, a reflective polarizing element RP, and a quarter-wave plate QWP, which are sequentially arranged from the first side to the second side along the optical axis. The reflective polarizing element RP is arranged on a second side surface of the first lens E1, and the quarter-wave plate QWP is arranged on a second side surface of the reflective polarizing element RP. The second lens assembly G2 includes a second lens E2, a partially-reflective element BS, and a third lens E3, which are sequentially arranged from the first side to the second side along the optical axis. The second lens E2 and the third lens E3 are cemented to each other. The partially-reflective element BS is arranged between the second lens E2 and the third lens E3. In actual use, the visual system according to the embodiment of the disclosure, for example, is used as a VR lens, and in this case, the first side corresponds to a human eye side, and the second side corresponds to a display or an imaging surface side. The second side of the visual system, for example, has a display or an imaging surface IMG. A light beam emitted from the IMG is able to reach the reflective polarizing element RP by sequentially passing through the third lens E3, the partially-reflective element BS, the second lens E2, and the quarter-wave plate QWP, is reflected at the reflective polarizing element RP, and reaches the partially-reflective element BS by passing through the quarter-wave plate QWP and the second lens E2 again. Then, the light beam is reflected at the partially-reflective element BS again, and sequentially passes through the second lens E2, the quarter-wave plate QWP, the reflective polarizing element RP, and the first lens E1 to emit toward the first side (e.g., at a diaphragm STO in FIG. 1). The visual system provided in the disclosure folds a required optical path by means of combining light reflection and refraction without affecting projection quality, such that a body length of the visual system is effectively shortened.

In an embodiment, the visual system of the disclosure satisfies a conditional expression 5.69≤fz/fm≤8.09, wherein fz is a combined focal length of the first lens assembly, that is, a combined focal length of the first lens, the reflective polarizing element, and the quarter-wave plate; and fm is an effective focal length of the visual system in a +2D state.

In an embodiment, the visual system of the disclosure satisfies a conditional expression 1.78≤f23/(TDm+TDn)≤7.01, wherein f23 is a combined focal length of the second lens and the third lens; TDm is a distance from the first side surface of the first lens to the second side surface of the third lens on the optical axis when the visual system is in the +2D state; and TDn is a distance from the first side surface of the first lens to the second side surface of the third lens on the optical axis when the visual system is in a −5D state.

In an embodiment, the visual system of the disclosure satisfies a conditional expression 2.00≤T12m/Δf≤4.70, wherein T12m is a distance from the second side surface of the first lens to the first side surface of the second lens on the optical axis when the visual system is in the +2D state, that is, an air gap between the first lens and the second lens; and Δf is a change in the effective focal length of the visual system switching from the +2D state to the −5D state, that is, a difference value between the effective focal length fm of the visual system in the +2D state and the effective focal length fn of the visual system in the −5D state.

The visual system according to the embodiment of the disclosure includes the first lens assembly and the second lens assembly from the first side to the second side along the optical axis. The first lens assembly includes the first lens, the reflective polarizing element, and the quarter-wave plate; and the second lens assembly includes the second lens, the partially-reflective element, and the third lens. The first lens has the positive refractive power, the first side surface thereof is a convex surface and the second side surface thereof is a planar surface. The second lens has the positive refractive power, the second side surface thereof is a convex surface. The third lens has the positive or negative refractive power, the first side surface thereof is a concave surface and the second side surface thereof is a convex surface. The second lens and the third lens are cemented to each other and form a dually cemented lens. The second lens assembly is configured to be able to move along the optical axis to close to or far away from a display located on the second side, and to cause the visual system to switch between the first state and the second state. Through the rational configuration of the visual system, and when the combined focal length fz of the first lens assembly and the effective focal length fm of the visual system in the first state satisfy the conditional expression 5.69≤fz/fm≤8.09, and by controlling the combined focal length f23 of the second lens and the third lens and the distances TDm and TDn from the first side surface of the first lens to the second side surface of the third lens on the optical axis when the system is in the first state and the second state respectively to satisfy the conditional expression 1.78≤f23/(TDm+TDn)≤7.01, and controlling the air gap T12m between the first lens and the second lens when the system is in the first state and the change Δf in the effective focal length of the system switching from the first state to the second state to satisfy the conditional expression 2.00≤T12m/Δf≤4.70, the total length of the system is able to be reduced while an optimal system achieves a diopter adjustment function, such that the overall processability of the system is ensured, and system stray light is able to be reduced.

In an embodiment, the visual system of the disclosure satisfies a conditional expression 3.55<(CT2+CT3)/ΔL<3.95, wherein CT2 is a center thickness of the second lens on the optical axis; CT3 is a center thickness of the third lens on the optical axis; and ΔL is a distance of the second lens assembly moving along the optical axis during a switching of the visual system from the +2D state to the −5D state. By controlling the conditional expression, while the processability of the lens is ensured, the total length of the system is able to be reduced by reducing a total thickness of two lenses.

In an embodiment, the visual system of the disclosure satisfies a conditional expression 3.45≤R1/fn≤4.52, wherein R1 is a radius of curvature of the first side surface of the first lens; and fn is an effective focal length of the visual system in the −5D state. By controlling the conditional expression, the contribution of the first lens to the overall imaging of the system is able to be ensured, and the imaging performance of the system is improved.

In an embodiment, the visual system of the disclosure satisfies a conditional expression 4.7<(CT1+CTR+CTQ)/T12n<6.65, wherein CT1 is a center thickness of the first lens on the optical axis; CTR is a center thickness of the reflective polarizing element on the optical axis; CTQ is a center thickness of the quarter-wave plate on the optical axis; and T12n is a distance from the second side surface of the first lens to the first side surface of the second lens on the optical axis when the visual system is in the −5D state. By controlling the conditional expression, while the processability of elements such as the lens is ensured, the total length of the system is able to be reduced by reducing the thickness.

In an embodiment, the visual system of the disclosure satisfies a conditional expression 0.38 mm≤|f2/f3|×Δf≤2.08 mm, wherein f2 is an effective focal length of the second lens; f3 is an effective focal length of the third lens; and Δf is a change in the effective focal length of the visual system switching from the +2D state to the −5D state. By rationally controlling the conditional expression range, it ensures that the change in the diopter satisfies requirements when the second lens and the third lens are moved.

In an embodiment, the visual system of the disclosure satisfies a conditional expression 5.0<TDn/(f1/V1)<7.9, wherein TDn is the distance from the first side surface of the first lens to the second side surface of the third lens on the optical axis when the visual system is in the −5D state; f1 is an effective focal length of the first lens; and V1 is an Abbe number of the first lens. By rationally controlling the conditional expression range, an overall space occupied by the system is able to be reduced to make a product thinner and lighter.

In an embodiment, the visual system of the disclosure satisfies a conditional expression 3.75<BFLn/T12n<6.95, wherein BFLn is a distance from the second side surface of the third lens to the display on the optical axis when the visual system is in the −5D state; and T12n is a distance from the second side surface of the first lens to the first side surface of the second lens on the optical axis when the visual system is in the −5D state. By rationally controlling the conditional expression range, it ensures that the second lens and the third lens have enough movement space when an optical system adjusts a diopter, such that the system satisfies an adjustment requirement within the range from −5D to +2D.

In an embodiment, the visual system of the disclosure satisfies a conditional expression 1.05<CT3/BFLm<1.45, wherein CT3 is a center thickness of the third lens on the optical axis; and BFLm is a distance from the second side surface of the third lens to the display on the optical axis when the visual system is in the +2D state. By rationally controlling the conditional expression range, it ensures that the third lens does not interfere with the display when the optical system adjusts the diopter, and the processability of the system is able to be ensured.

In an embodiment, the visual system of the disclosure satisfies a conditional expression −6.81 mm≤(f2/R4)×T12 m≤−3.74 mm, wherein f2 is an effective focal length of the second lens; R4 is a radius of curvature of the second side surface of the second lens; and T12m is a distance from the second side surface of the first lens to the first side surface of the second lens on the optical axis when the visual system is in the +2D state. By rationally controlling the conditional expression range, it ensures that the second lens and the third lens have enough movement space when an optical system adjusts a diopter, such that the system satisfies an adjustment requirement within the range from −5D to +2D.

In an embodiment, the visual system of the disclosure satisfies a conditional expression 3.12 mm≤|f3/R5|×BFLm≤6.12 mm, wherein f3 is an effective focal length of the third lens; R5 is a radius of curvature of the first side surface of the third lens; and BFLm is a distance from the second side surface of the third lens to the display on the optical axis when the visual system is in the +2D state. By rationally controlling the conditional expression range, a cementing yield of the third lens and the second lens may be increased while the performance of the system is ensured.

In an embodiment, the visual system of the disclosure satisfies a conditional expression 7.10≤fn/ΔL≤7.58, wherein fn is the effective focal length of the visual system in the −5D state; and ΔL is the distance of the second lens assembly moving along the optical axis during the switching of the visual system from the +2D state to the −5D state. By rationally controlling the conditional expression range, it ensures that the visual system has enough space for each state in the range from −5D to +2D, which makes it easy for the user to find the state suitable for him/her more quickly when using the system.

In an embodiment, the visual system of the disclosure satisfies a conditional expression 4.82≤EPD/Δf≤12.15, wherein EPD is an entrance pupil diameter of the visual system; and Δf is the change in the effective focal length of the visual system switching from the +2D state to the −5D state. By rationally controlling the conditional expression range, when the user uses the visual system, the EPD of the system is able to be greater than a pupil diameter of a human eye, thereby ensuring an imaging performance of a light emitted by a display screen in the human eyes.

In an embodiment, the visual system of the disclosure satisfies a conditional expression −4.33 mm≤(R1/R6)×ΔL≤−0.34 mm, wherein R1 is a radius of curvature of the first side surface of the first lens; R6 is a radius of curvature of the second side surface of the third lens; and ΔL is the distance of the second lens assembly moving along the optical axis during the switching of the visual system from the +2D state to the −5D state. By rationally controlling the conditional expression range, while the imaging performance of the system is ensured, the first lens and the third lens are not be difficult to process due to excessive curvature, thereby improving the processability of the first lens and the third lens.

In an embodiment, the visual system of the disclosure satisfies a conditional expression 1.61≤f23/(fm+fn)≤5.84, wherein f23 is the combined focal length of the second lens and the third lens; fm is the effective focal length of the visual system in a +2D state; and fn is the effective focal length of the visual system in the −5D state. By rationally controlling the conditional expression range, light is able to be better converged, thereby improving the imaging performance of the system.

In an embodiment, the visual system of the disclosure satisfies a conditional expression 5.90≤|f3|/TDm≤12.19, wherein f3 is the effective focal length of the third lens; and TDm is the distance from the first side surface of the first lens to the second side surface of the third lens on the optical axis when the visual system is in the +2D state. By rationally controlling the conditional expression range, light is able to be better converged, and a sensitivity tolerance of the lens is able to be reduced while an imaging requirement is met.

In the visual system according to the embodiment of the disclosure, one or more of the first lens, the second lens, and the third lens is the aspheric lens. The aspheric lens has a better radius of curvature characteristic, and has the advantages of improving a distorted aberration and improving an astigmatic aberration. After the aspheric lens is used, the aberration occurring during imaging is able to be eliminated as much as possible, thereby improving the imaging quality.

In an embodiment, the visual system disclosed in the disclosure includes the first lens assembly and the second lens assembly from the first side to the second side along the optical axis. The first lens assembly includes the first lens, the reflective polarizing element, and the quarter-wave plate; and the second lens assembly includes the second lens, the partially-reflective element, and the third lens. The first lens has the positive refractive power, the first side surface thereof is a convex surface and the second side surface thereof is a planar surface. The second lens has the positive refractive power, the second side surface thereof is a convex surface. The third lens has the positive or negative refractive power, the first side surface thereof is a concave surface and the second side surface thereof is a convex surface. The second lens and the third lens are cemented to each other and form a dually cemented lens. The second lens assembly is configured to be able to move along the optical axis to close to or far away from a display located on the second side, and to cause the visual system to switch between a first state and a second state. Through the rational configuration of the visual system, and when the combined focal length fz of the first lens assembly and the effective focal length fm of the visual system in the first state satisfy the conditional expression 5.69≤fz/fm≤8.09, and by controlling the combined focal length f23 of the second lens and the third lens and the distances TDm and TDn from the first side surface of the first lens to the second side surface of the third lens on the optical axis when the system is in the first state and the second state respectively to satisfy the conditional expression 1.78≤f23/(TDm+TDn)≤7.01, and controlling the air gap T12m between the first lens and the second lens when the system is in the first state and the change Δf in the effective focal length of the system switching from the first state to the second state to satisfy the conditional expression 2.00≤T12m/Δf≤4.70, the total length of the system is able to be reduced while an optimal system achieves a diopter adjustment function, such that the overall processability of the system is ensured, and system stray light is able to be reduced.

In another embodiment, the visual system according to the embodiment of the disclosure includes the first lens assembly and the second lens assembly from the first side to the second side along the optical axis. The first lens assembly includes the first lens, the reflective polarizing element, and the quarter-wave plate; and the second lens assembly includes the second lens, the partially-reflective element, and the third lens. The first lens has the positive refractive power, the first side surface thereof is a convex surface and the second side surface thereof is a planar surface. The second lens has the positive refractive power, the second side surface thereof is a convex surface. The third lens has the positive or negative refractive power, the first side surface thereof is a concave surface and the second side surface thereof is a convex surface. The second lens and the third lens are cemented to each other and form a dually cemented lens. The second lens assembly is configured to be able to move along the optical axis to close to or far away from a display located on the second side, and to cause the visual system to switch between a first state and a second state. Through the rational configuration of the visual system, and when the combined focal length fz of the first lens assembly and the effective focal length fm of the visual system in the first state satisfy the conditional expression 5.69≤fz/fm≤8.09, and by controlling the combined focal length f23 of the second lens and the third lens and the on-axis distances TDm and TDn from the first side surface of the first lens to the second side surface of the third lens when the system is in the first state and the second state respectively to satisfy the conditional expression 1.78≤f23/(TDm+TDn)≤7.01, and controlling the radius of curvature R1 of the first side surface of the first lens, the radius of curvature R6 of the second side surface of the third lens, and the distance ΔL of the second lens assembly moving along the optical axis during the switching of the visual system from the first state to the second state to satisfy the conditional expression −4.33 mm≤(R1/R6)×ΔL≤−0.34 mm, the optical system can achieve the function of adjusting the diopter, the total length of the system is reduced, the imaging performance of the system is able to be ensured, and the first lens and the third lens are not be difficult to process due to excessive curvature, thereby improving the processability of the first lens and the third lens.

The visual system according to the embodiment of the disclosure adopts, for example, a cemented three-lens foldback optical solution. By rationally configuring the structure and parameters of the system, a total optical length is able to be reduced, the total amount of the system is reduced, the miniaturization and lightweight of the system is achieved, and the use comfort of the user is improved; and through the movement of the second lens assembly, the system is also able to achieve the zooming within the range from −5D to +2D, so as to satisfy the requirements of the users with different vision, and the users do not need to wear glasses to enjoy the VR experience. Furthermore, reflected stray light between the lenses is also able to be effectively reduced, and the risk of imaging ghost images is reduced, thereby facilitating the improvement of the imaging quality of the system.

Furthermore, the disclosure further provides a VR device. The VR device includes the visual system provided in any one of the above embodiments. The first side is a human eye side, and the second side is a display/an imaging surface side. The VR device has the characteristics of miniaturization, lightweight, high image quality, and the like, and zooms within a range from −5D to +2D, such that users with different vision do not need to wear glasses to clearly enjoy VR experience, thus causing the users to have a better application experience.

Specific embodiments of the visual system applicable to the above embodiment are further described below with reference to the drawings.

### Embodiment 1

A visual system according to Embodiment 1 of the disclosure is described below with reference to FIGS. 1-4.

The visual system according to Embodiment 1 of the disclosure sequentially includes from a first side to a second side along an optical axis: a first lens assembly G1 and a second lens assembly G2. The first lens assembly G1 includes a first lens E1, a reflective polarizing element RP, and a quarter-wave plate QWP, which are sequentially arranged from the first side to the second side along the optical axis. The reflective polarizing element RP is arranged on a second side surface of the first lens E1, and the quarter-wave plate QWP is arranged on a second side surface of the reflective polarizing element RP. The second lens assembly G2 includes a second lens E2, a partially-reflective element BS, and a third lens E3, which are sequentially arranged from the first side to the second side along the optical axis. The second lens E2 and the third lens E3 are cemented to each other. The partially-reflective element BS is arranged between the second lens E2 and the third lens E3.

In the embodiment, the first lens E1 has a positive refractive power, a first side surface thereof is a convex surface and a second side surface thereof is a planar surface; the second lens E2 has a positive refractive power, a first side surface thereof is a convex surface and a second side surface thereof is a convex surface; and the third lens E3 has a negative refractive power, a first side surface thereof is a concave surface and a second side surface thereof is a convex surface.

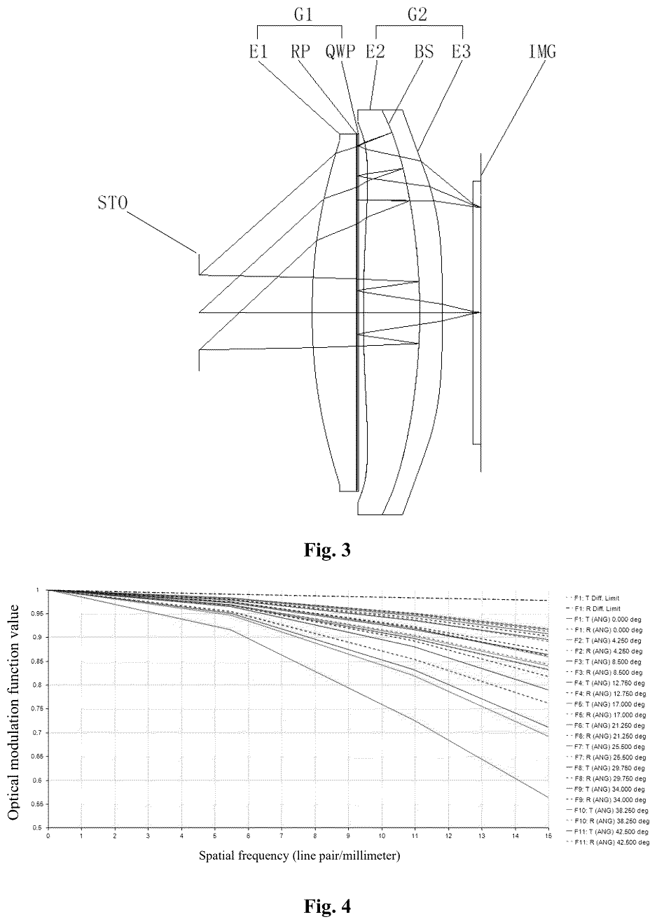

In the embodiment, a diaphragm STO is arranged on the first side of the visual system, and a display/an imaging surface IMG is arranged on the second side of the visual system. The first lens assembly G1: distances of the first lens E1, the reflective polarizing element RP, and the quarter-wave plate QWP from the display/the imaging surface IMG in an optical axis direction are relatively fixed. The second lens assembly G2: the second lens E2, the partially-reflective element BS, and the third lens E3 are able to move in the optical axis direction to close to or away from the display/the imaging surface IMG, and in this process, the visual system is able to zoom within a range from −5D to +2D. FIG. 1 shows a structural schematic diagram of the visual system when the second lens assembly G2 moves along the optical axis to a position closest to the display/imaging surface IMG. In this case, the visual system is in a +2D state. FIG. 3 shows a structural schematic diagram of the visual system when the second lens assembly G2 moves along the optical axis to a position farthest away from the display/imaging surface IMG. In this case, the visual system is in a −5D state.

As shown in FIG. 1 and FIG. 3, in a specific application of the visual system according to the embodiment, image light from the display/the imaging surface IMG is able to reach the reflective polarizing element RP by sequentially passing through the third lens E3, the partially-reflective element BS, the second lens E2, and the quarter-wave plate QWP, is reflected at the reflective polarizing element RP, and reaches the partially-reflective element BS by passing through the quarter-wave plate QWP and the second lens E2 again. Then, the light beam is reflected at the partially-reflective element BS again, and sequentially passes through the second lens E2, the quarter-wave plate QWP, the reflective polarizing element RP, and the first lens E1 to the diaphragm, and finally images in a predetermined position. For example, light of the visual system that is reflected twice is able to be finally projected to the pupil of a user.

Table 1 shows basic structure parameters of the visual system in Embodiment 1; and radius of curvature, and thickness/distance are all in millimeters (mm).

TABLE 1

| | | Surface | Radius of | Thickness/ | Refractive | Abbe | Refraction/ | Conic |
|---|---|---|---|---|---|---|---|---|
| Surface | Element | type | curvature | distance | index | number | Reflection | coefficient |
| S0 | | Spherical | Infinite | D1 | | | Refraction | |
| S1 | | Spherical | Infinite | 0.0000 | | | Refraction | |
| S2 | Diaphragm | Spherical | Infinite | 12.0000 | | | Refraction | |
| | (STO) | | | | | | | |
| S3 | First lens (E1) | Aspheric | 60.0346 | 4.6898 | 1.548 | 56.30 | Refraction | 2.5600 |
| S4 | Reflective | Spherical | Infinite | 0.1180 | 1.495 | 57.47 | Refraction | |
| | polarizing | | | | | | | |
| | element (RP) | | | | | | | |
| S5 | Quarter- | Spherical | Infinite | 0.1340 | 1.495 | 57.47 | Refraction | |
| | wave plate | | | | | | | |
| | (QWP) | | | | | | | |
| S6 | | Spherical | Infinite | D2 | | | Refraction | |
| S7 | Second lens | Aspheric | 144.7811 | 6.0000 | 1.548 | 56.30 | Refraction | 5.5641 |
| | (E2) | | | | | | | |
| S8 | Partially- | Aspheric | −68.3933 | −6.0000 | 1.548 | 56.30 | Reflection | 0.0418 |
| | reflective | | | | | | | |
| | element (BS) | | | | | | | |
| S9 | | Aspheric | 144.7811 | D3 | | | Refraction | 5.5641 |
| S10 | | Spherical | Infinite | −0.1340 | 1.495 | 57.47 | Refraction | |
| S11 | Reflective | Spherical | Infinite | 0.1340 | 1.495 | 57.47 | Reflection | |
| | polarizing | | | | | | | |
| | element (RP) | | | | | | | |
| S12 | | Spherical | Infinite | D4 | | | Refraction | |
| S13 | Second lens | Aspheric | 144.7811 | 6.0000 | 1.548 | 56.30 | Refraction | 5.5641 |
| | (E2) | | | | | | | |
| S14 | Third lens | Aspheric | −68.3933 | 2.4126 | 1.548 | 56.30 | Refraction | 0.0418 |
| | (E3) | | | | | | | |
| S15 | | Aspheric | −357.1282 | D5 | | | Refraction | −99.0000 |
| S16 | | Spherical | Infinite | 0.9000 | 1.519 | 64.17 | Refraction | |
| S17 | | Spherical | Infinite | 0.0000 | | | Refraction | |
| S18 | Image | Spherical | Infinite | 0.0000 | | | Refraction | |
| | surface (IMG) | | | | | | | |

The parameters D1 to D5 in Table 1 are understood as follows: D5 is understood as a value from the display/the imaging surface IMG to the second side surface of the third lens E3 along the optical axis; D4 is understood as a value from the first side surface of the second lens E2 to the second side surface of the quarter-wave plate QWP along the optical axis; D3 is understood as a value from the second side surface of the quarter-wave plate QWP to the first side surface of the second lens E2 along the optical axis; D2 is understood as a value from the first side surface of the second lens E2 to the second side surface of the quarter-wave plate QWP along the optical axis; and D1 is understood as a value of a VID of the visual system according to the embodiment. In the process of the visual system according to the embodiment to zoom through the movement of the second lens assembly G2 along the optical axis, the values of the above parameters D1 to D5 vary accordingly. The values of the parameters D1 to D5 of the visual system in the +2D state shown in FIG. 1 and the −5D state shown in FIG. 3 are shown in Table 2 below.

TABLE 2

| | D1 | D2 | D3 | D4 | D5 |
|---|---|---|---|---|---|
| +2D state | 500.0000 | 2.7456 | −2.7456 | 2.7456 | 1.0000 |
| −5D state | −200.0000 | 0.5194 | −0.5194 | 0.5194 | 3.2262 |

In the embodiment, the first side surface S3 of the first lens E1, the first side surface S13 of the second lens E2, a cemented surface S14 of the second lens E2 and the third lens E3, and the second side surface S15 of the third lens E3 are all aspheric surfaces, and the surface types of various aspheric lenses are limited by using, but not limited to, the following aspheric formula.

$$x = \frac{{ch}^{2}}{1 + \sqrt{1 - ( k + 1 ) {c}^{2} {h}^{2}}} + \sum {Aih}^{i} \qquad ( 1 )$$

Where x is a vector height of a distance between the aspheric surface and a vertex of the aspheric surface when the aspheric surface is located at a position with the height h in an optical axis direction; c is a paraxial curvature of the aspheric surface, c=1/R, i.e., the paraxial curvature c is a reciprocal of the radius of curvature R in Table 1; k is a conic coefficient; and Ai is a correction coefficient for an i-th order of the aspheric surface. Table 3 below provides higher-order term coefficients A4, A6, A8, A10, A12, A14, A16, A18, and A20 applied to each of the aspheric lenses S3 and S13-S15 in the embodiment.

TABLE 3

| | Surface | | | |
|---|---|---|---|---|
| Coefficient | S3 | S13 | S14 | S15 |
| A4 | −1.1105E−06 | −1.8981E−06 | 7.4443E−07 | −5.0283E−05 |
| A6 | 1.0020E−08 | −1.8679E−08 | −2.6128E−09 | 1.2222E−07 |
| A8 | −3.3669E−11 | −1.3839E−11 | −8.2786E−12 | −1.4558E−10 |
| A10 | 0.0000E+00 | 0.0000E+00 | 0.0000E+00 | 0.0000E+00 |
| A12 | 0.0000E+00 | 0.0000E+00 | 0.0000E+00 | 0.0000E+00 |
| A14 | 0.0000E+00 | 0.0000E+00 | 0.0000E+00 | 0.0000E+00 |
| A16 | 0.0000E+00 | 0.0000E+00 | 0.0000E+00 | 0.0000E+00 |
| A18 | 0.0000E+00 | 0.0000E+00 | 0.0000E+00 | 0.0000E+00 |
| A20 | 0.0000E+00 | 0.0000E+00 | 0.0000E+00 | 0.0000E+00 |

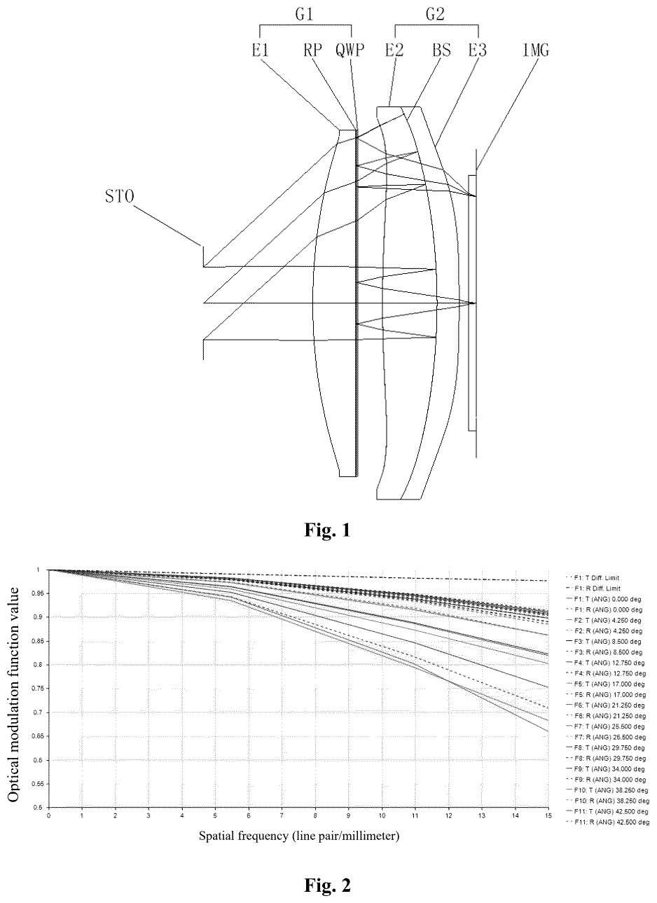

FIG. 2 shows an MTF curve of the visual system in the +2D state shown in FIG. 1 according to the embodiment. FIG. 4 shows an MTF curve of the visual system in the −5D state shown in FIG. 3 according to the embodiment. The MTF curve indicates optical modulation function values corresponding to different spatial frequencies. From FIG. 2 and FIG. 4, it is seen that, the visual system provided in the embodiment is able to achieve good imaging quality at two different focal lengths of +2D and −5D.

### Embodiment 2

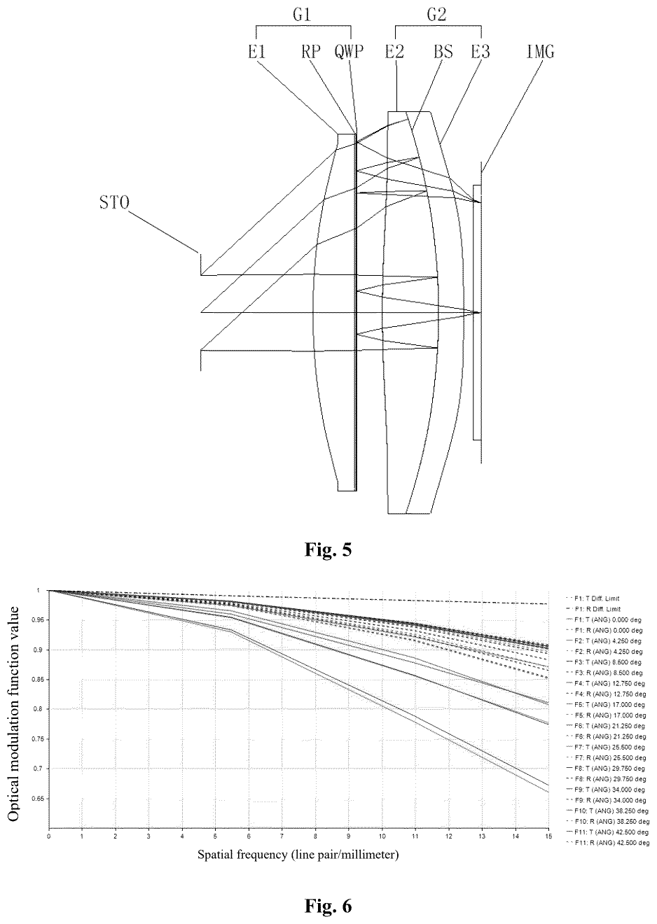

A visual system according to Embodiment 2 of the disclosure is described below with reference to FIGS. 5-8. In the embodiment and the embodiments below, for the sake of brevity, a portion of the description similar to Embodiment 1 will be omitted.

In the embodiment, the visual system sequentially includes from a first side to a second side along an optical axis: a first lens assembly G1 and a second lens assembly G2. The first lens assembly G1 includes a first lens E1, a reflective polarizing element RP, and a quarter-wave plate QWP, which are sequentially arranged from the first side to the second side along the optical axis. The reflective polarizing element RP is arranged on a second side surface of the first lens E1, and the quarter-wave plate QWP is arranged on a second side surface of the reflective polarizing element RP. The second lens assembly G2 includes a second lens E2, a partially-reflective element BS, and a third lens E3, which are sequentially arranged from the first side to the second side along the optical axis. The second lens E2 and the third lens E3 are cemented to each other. The partially-reflective element BS is arranged between the second lens E2 and the third lens E3.

In the embodiment, the first lens E1 has a positive refractive power, a first side surface thereof is a convex surface and a second side surface thereof is a planar surface; the second lens E2 has a positive refractive power, a first side surface thereof is a convex surface and a second side surface thereof is a convex surface; and the third lens E3 has a negative refractive power, a first side surface thereof is a concave surface and a second side surface thereof is a convex surface.

Table 4 shows basic parameters of the visual system according to the embodiment.

TABLE 4

| | | Surface | Radius of | Thickness/ | Refractive | Abbe | Refraction/ | Conic |
|---|---|---|---|---|---|---|---|---|
| Surface | Element | type | curvature | distance | index | number | Reflection | coefficient |
| S0 | | Spherical | Infinite | D1 | | | Refraction | |
| S1 | | Spherical | Infinite | 0.0000 | | | Refraction | |
| S2 | Diaphragm | Spherical | Infinite | 12.0000 | | | Refraction | |
| | (STO) | | | | | | | |
| S3 | First lens | Aspheric | 63.0938 | 4.4646 | 1.548 | 56.30 | Refraction | 6.1882 |
| | (E1) | | | | | | | |
| S4 | Reflective | Spherical | Infinite | 0.1180 | 1.495 | 57.47 | Refraction | |
| | polarizing | | | | | | | |
| | element | | | | | | | |
| | (RP) | | | | | | | |
| S5 | Quarter- | Spherical | Infinite | 0.1340 | 1.495 | 57.47 | Refraction | |
| | wave plate | | | | | | | |
| | (QWP) | | | | | | | |
| S6 | | Spherical | Infinite | D2 | | | Refraction | |
| S7 | Second lens | Aspheric | 147.7841 | 6.0000 | 1.548 | 56.30 | Refraction | −12.0279 |
| | (E2) | | | | | | | |
| S8 | Partially- | Aspheric | −67.9539 | −6.0000 | 1.548 | 56.30 | Reflection | −0.0396 |
| | reflective | | | | | | | |
| | element (BS) | | | | | | | |
| S9 | | Aspheric | 147.7841 | D3 | | | Refraction | −12.0279 |
| S10 | | Spherical | Infinite | −0.1340 | 1.495 | 57.47 | Refraction | |
| S11 | Reflective | Spherical | Infinite | 0.1340 | 1.495 | 57.47 | Reflection | |
| | polarizing | | | | | | | |
| | element | | | | | | | |
| | (RP) | | | | | | | |
| S12 | | Spherical | Infinite | D4 | | | Refraction | |
| S13 | Second lens | Aspheric | 147.7841 | 6.0000 | 1.548 | 56.30 | Refraction | −12.0279 |
| | (E2) | | | | | | | |
| S14 | Third lens | Aspheric | −67.9539 | 2.6736 | 1.548 | 56.30 | Refraction | −0.0396 |
| | (E3) | | | | | | | |
| S15 | | Aspheric | −410.2316 | D5 | | | Refraction | −96.9833 |
| S16 | | Spherical | Infinite | 0.9000 | 1.519 | 64.17 | Refraction | |
| S17 | | Spherical | Infinite | 0.0000 | | | Refraction | |
| S18 | Image | Spherical | Infinite | 0.0000 | | | Refraction | |
| | surface IMG) | | | | | | | |

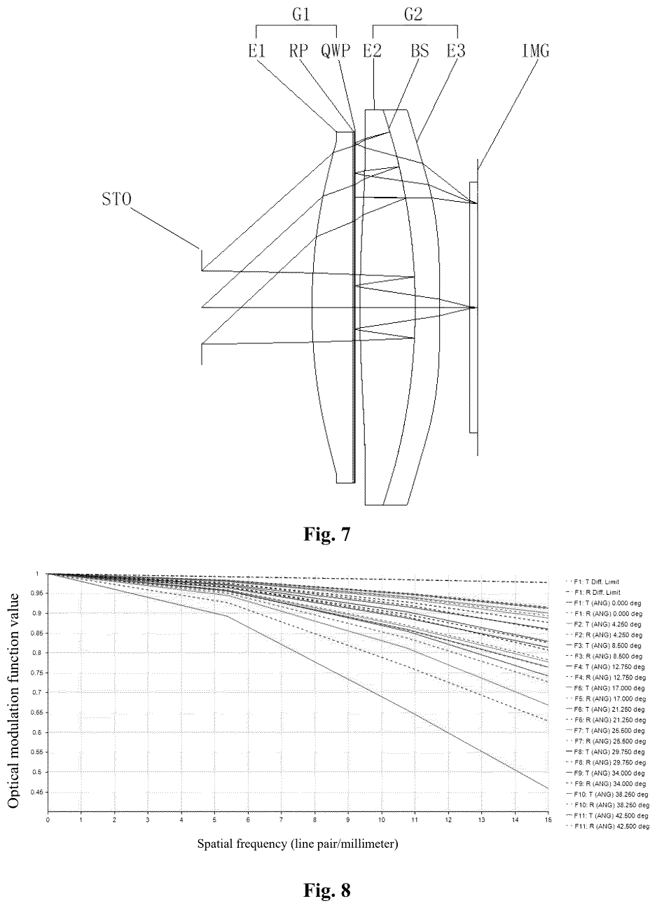

In the embodiment, a diaphragm STO is arranged on the first side of the visual system, and a display/an imaging surface IMG is arranged on the second side of the visual system. The first lens assembly G1: distances of the first lens E1, the reflective polarizing element RP, and the quarter-wave plate QWP from the display/the imaging surface IMG in an optical axis direction are relatively fixed. The second lens assembly G2: the second lens E2, the partially-reflective element BS, and the third lens E3 are able to move in the optical axis direction to close to or away from the display/the imaging surface IMG, and in this process, the visual system is able to zoom within a range from −5D to +2D. FIG. 5 shows a structural schematic diagram of the visual system when the second lens assembly G2 moves along the optical axis to a position closest to the display/the imaging surface IMG. In this case, the visual system is in a +2D state. FIG. 7 shows a structural schematic diagram of the visual system when the second lens assembly G2 moves along the optical axis to a position farthest away from the display/imaging surface IMG. In this case, the visual system is in a −5D state.

When the visual system according to the embodiment is in the +2D state shown in FIG. 5 and the −5D state shown in FIG. 7, the values of the corresponding parameters D1 to D5 in Table 4 are shown in Table 5 below.

TABLE 5

| | D1 | D2 | D3 | D4 | D5 |
|---|---|---|---|---|---|
| +2D state | 500.0000 | 2.7097 | −2.7097 | 2.7097 | 1.0000 |
| −5D state | −200.0000 | 0.5000 | −0.5000 | 0.5000 | 3.2097 |

In the embodiment, the first side surface S3 of the first lens E1, the first side surface S13 of the second lens E2, a cemented surface S14 of the second lens E2 and the third lens E3, and the second side surface S15 of the third lens E3 are all aspheric surfaces. The surface types of various aspheric surfaces are calculated by using the formula (1) in Embodiment 1. Table 6 below provides higher-order term coefficients A4, A6, A8, A10, A12, A14, A16, A18, and A20 applied to each of the aspheric lenses S3 and S13-S15 in the embodiment.

TABLE 6

| | Surface | | | |
|---|---|---|---|---|
| Coefficient | S3 | S13 | S14 | S15 |
| A4 | −2.5823E−06 | −8.6508E−07 | 8.4887E−07 | −5.2823E−05 |
| A6 | 7.7705E−09 | −2.4100E−08 | −5.2145E−09 | 1.4439E−07 |
| A8 | −4.4558E−11 | 3.6853E−11 | 6.7984E−12 | −1.4646E−10 |
| A10 | 0.0000E+00 | 0.0000E+00 | 0.0000E+00 | 0.0000E+00 |
| A12 | 0.0000E+00 | 0.0000E+00 | 0.0000E+00 | 0.0000E+00 |
| A14 | 0.0000E+00 | 0.0000E+00 | 0.0000E+00 | 0.0000E+00 |
| A16 | 0.0000E+00 | 0.0000E+00 | 0.0000E+00 | 0.0000E+00 |
| A18 | 0.0000E+00 | 0.0000E+00 | 0.0000E+00 | 0.0000E+00 |
| A20 | 0.0000E+00 | 0.0000E+00 | 0.0000E+00 | 0.0000E+00 |

FIG. 6 shows an MTF curve of the visual system in the +2D state shown in FIG. 5 according to the embodiment. FIG. 8 shows an MTF curve of the visual system in the −5D state shown in FIG. 7 according to the embodiment. From FIG. 6 and FIG. 8, it is seen that, the visual system provided in the embodiment is able to achieve good imaging quality at two different focal lengths of +2D and −5D.

### Embodiment 3

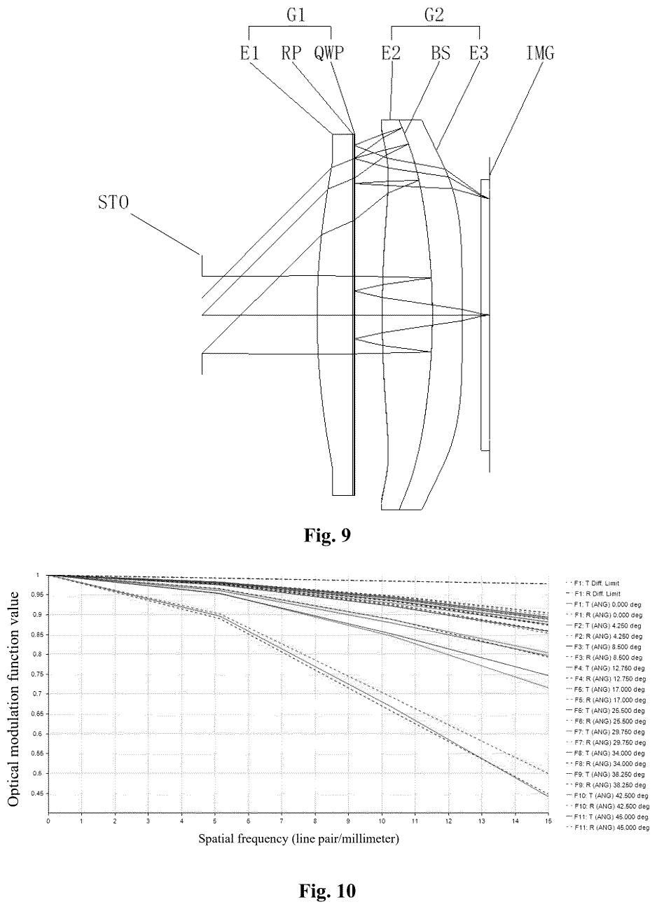

A visual system according to Embodiment 3 of the disclosure is described below with reference to FIGS. 9-12.

In the embodiment, the visual system sequentially includes from a first side to a second side along an optical axis: a first lens assembly G1 and a second lens assembly G2. The first lens assembly G1 includes a first lens E1, a reflective polarizing element RP, and a quarter-wave plate QWP, which are sequentially arranged from the first side to the second side along the optical axis. The reflective polarizing element RP is arranged on a second side surface of the first lens E1, and the quarter-wave plate QWP is arranged on a second side surface of the reflective polarizing element RP. The second lens assembly G2 includes a second lens E2, a partially-reflective element BS, and a third lens E3, which are sequentially arranged from the first side to the second side along the optical axis. The second lens E2 and the third lens E3 are cemented to each other. The partially-reflective element BS is arranged between the second lens E2 and the third lens E3.

In the embodiment, the first lens E1 has a positive refractive power, a first side surface thereof is a convex surface and a second side surface thereof is a planar surface; the second lens E2 has a positive refractive power, a first side surface thereof is a convex surface and a second side surface thereof is a convex surface; and the third lens E3 has a negative refractive power, a first side surface thereof is a concave surface and a second side surface thereof is a convex surface.

Table 7 shows basic parameters of the visual system according to the embodiment.

TABLE 7

| | | Surface | Radius of | Thickness/ | Refractive | Abbe | Refraction/ | Conic |
|---|---|---|---|---|---|---|---|---|
| Surface | Element | type | curvature | distance | index | number | Reflection | coefficient |
| S0 | | Spherical | Infinite | D1 | | | Refraction | |
| S1 | | Spherical | Infinite | 0.0000 | | | Refraction | |
| S2 | Diaphragm | Spherical | Infinite | 12.0000 | | | Refraction | |
| | (STO) | | | | | | | |
| S3 | First lens | Aspheric | 76.1328 | 3.7047 | 1.538 | 55.71 | Refraction | −2.4691 |
| | (E1) | | | | | | | |
| S4 | Reflective | Spherical | Infinite | 0.1180 | 1.495 | 57.47 | Refraction | |
| | polarizing | | | | | | | |
| | element (RP) | | | | | | | |
| S5 | Quarter- | Spherical | Infinite | 0.1340 | 1.495 | 57.47 | Refraction | |
| | wave plate | | | | | | | |
| | (QWP) | | | | | | | |
| S6 | | Spherical | Infinite | D2 | | | Refraction | |
| S7 | Second lens | Aspheric | 136.0077 | 5.2295 | 1.548 | 56.30 | Refraction | 3.5788 |
| | (E2) | | | | | | | |
| S8 | Partially- | Aspheric | −69.1944 | −5.2295 | 1.548 | 56.30 | Reflection | −4.3752 |
| | reflective | | | | | | | |
| | element (BS) | | | | | | | |
| S9 | | Aspheric | 136.0077 | D3 | | | Refraction | 3.5788 |
| S10 | | Spherical | Infinite | −0.1340 | 1.495 | 57.47 | Refraction | |
| S11 | Reflective | Spherical | Infinite | 0.1340 | 1.495 | 57.47 | Reflection | |
| | polarizing | | | | | | | |
| | element (RP) | | | | | | | |
| S12 | | Spherical | Infinite | D4 | | | Refraction | |
| S13 | Second lens | Aspheric | 136.0077 | 5.2295 | 1.548 | 56.30 | Refraction | 3.5788 |
| | (E2) | | | | | | | |
| S14 | Third lens | Aspheric | −69.1944 | 3.1086 | 1.548 | 56.30 | Refraction | −4.3752 |
| | (E3) | | | | | | | |
| S15 | | Aspheric | −497.3665 | D5 | | | Refraction | 99.0000 |
| S16 | | Spherical | Infinite | 0.9000 | 1.519 | 64.17 | Refraction | |
| S17 | | Spherical | Infinite | 0.0000 | | | Refraction | |
| S18 | Image | Spherical | Infinite | 0.0000 | | | Refraction | |
| | surface (IMG) | | | | | | | |

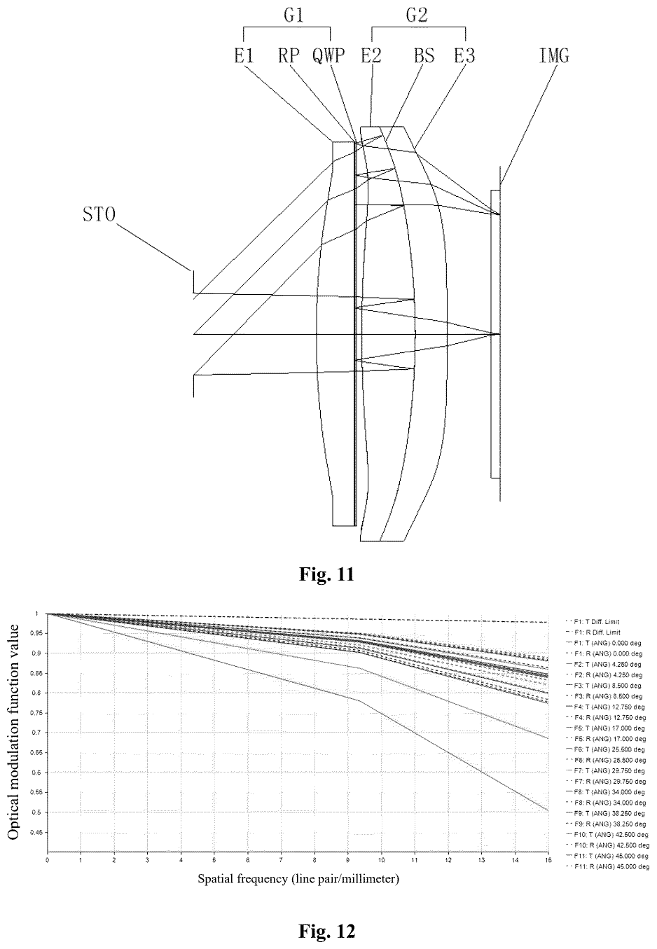

In the embodiment, a diaphragm STO is arranged on the first side of the visual system, and a display/an imaging surface IMG is arranged on the second side of the visual system. The first lens assembly G1: distances of the first lens E1, the reflective polarizing element RP, and the quarter-wave plate QWP from the display/the imaging surface IMG in an optical axis direction are relatively fixed. The second lens assembly G2: the second lens E2, the partially-reflective element BS, and the third lens E3 are able to move in the optical axis direction to close to or away from the display/the imaging surface IMG, and in this process, the visual system is able to zoom within a range from −5D to +2D. FIG. 9 shows a structural schematic diagram of the visual system when the second lens assembly G2 moves along the optical axis to a position closest to the display/the imaging surface IMG. In this case, the visual system is in a +2D state. FIG. 11 shows a structural schematic diagram of the visual system when the second lens assembly G2 moves along the optical axis to a position farthest away from the display/the imaging surface IMG. In this case, the visual system is in a −5D state.

When the visual system according to the embodiment is in the +2D state shown in FIG. 9 and the −5D state shown in FIG. 11, the values of the corresponding parameters D1 to D5 in Table 7 are shown in Table 8 below.

TABLE 8

| | D1 | D2 | D3 | D4 | D5 |
|---|---|---|---|---|---|
| +2D state | 500.0000 | 2.8431 | −2.8431 | 2.8431 | 1.9621 |
| −5D state | −200.0000 | 0.5000 | −0.5000 | 0.5000 | 4.3052 |

In the embodiment, the first side surface S3 of the first lens E1, the first side surface S13 of the second lens E2, a cemented surface S14 of the second lens E2 and the third lens E3, and the second side surface S15 of the third lens E3 are all aspheric surfaces. The surface types of various aspheric surfaces are calculated by using the formula (1) in Embodiment 1. Table 9 below provides higher-order term coefficients A4, A6, A8, A10, A12, A14, A16, A18, and A20 applied to each of the aspheric lenses S3 and S13-S15 in the embodiment.

TABLE 9

| | Surface | | | |
|---|---|---|---|---|
| Coefficient | S3 | S13 | S14 | S15 |
| A4 | −3.3529E−06 | 6.3217E−06 | 1.0519E−06 | −1.8918E−05 |
| A6 | 5.6160E−08 | −4.1329E−08 | −7.1716E−09 | −6.4969E−08 |
| A8 | −3.0280E−10 | −2.0279E−11 | 1.1061E−12 | −8.2977E−11 |
| A10 | 3.3153E−13 | 8.6953E−15 | −9.8159E−14 | 1.1771E−12 |
| A12 | 1.8348E−15 | −3.2705E−16 | 5.3726E−17 | −2.3007E−15 |
| A14 | −5.1091E−18 | −9.7813E−19 | 2.5803E−20 | 3.8165E−18 |
| A16 | 9.5426E−22 | 5.2286E−21 | 5.3595E−22 | −6.6010E−21 |
| A18 | 0.0000E+00 | 0.0000E+00 | 0.0000E+00 | 0.0000E+00 |
| A20 | 0.0000E+00 | 0.0000E+00 | 0.0000E+00 | 0.0000E+00 |

FIG. 10 shows an MTF curve of the visual system in the +2D state shown in FIG. 9 according to the embodiment. FIG. 12 shows an MTF curve of the visual system in the −5D state shown in FIG. 11 according to the embodiment. From FIG. 10 and FIG. 12, it is seen that, the visual system provided in the embodiment is able to achieve good imaging quality at two different focal lengths of +2D and −5D.

### Embodiment 4

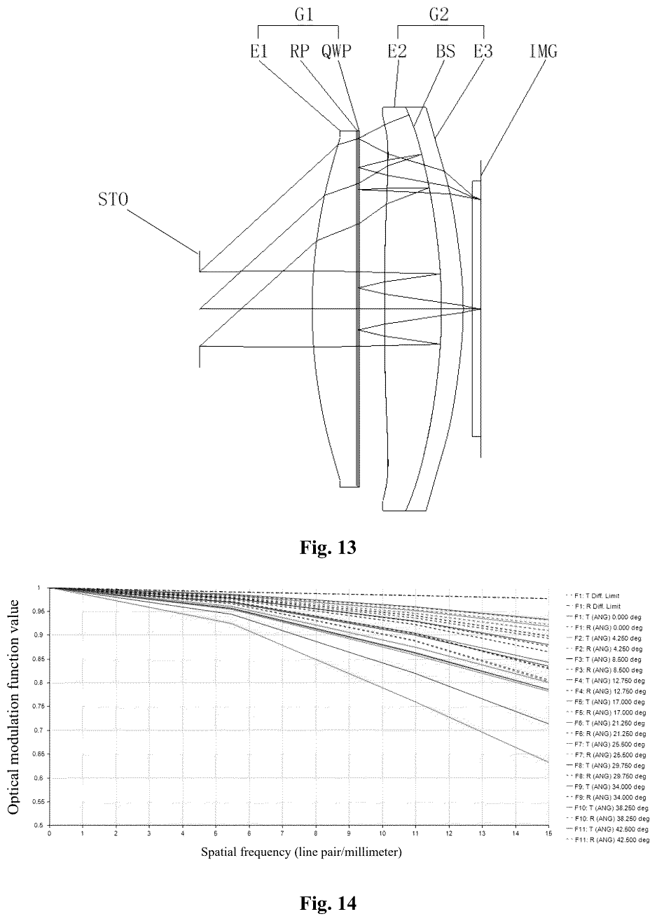

A visual system according to Embodiment 4 of the disclosure is described below with reference to FIGS. 13-16.

In the embodiment, the visual system sequentially includes from a first side to a second side along an optical axis: a first lens assembly G1 and a second lens assembly G2. The first lens assembly G1 includes a first lens E1, a reflective polarizing element RP, and a quarter-wave plate QWP, which are sequentially arranged from the first side to the second side along the optical axis. The reflective polarizing element RP is arranged on a second side surface of the first lens E1, and the quarter-wave plate QWP is arranged on a second side surface of the reflective polarizing element RP. The second lens assembly G2 includes a second lens E2, a partially-reflective element BS, and a third lens E3, which are sequentially arranged from the first side to the second side along the optical axis. The second lens E2 and the third lens E3 are cemented to each other. The partially-reflective element BS is arranged between the second lens E2 and the third lens E3.

In the embodiment, the first lens E1 has a positive refractive power, a first side surface thereof is a convex surface and a second side surface thereof is a planar surface; the second lens E2 has a positive refractive power, a first side surface thereof is a convex surface and a second side surface thereof is a convex surface; and the third lens E3 has a positive refractive power, a first side surface thereof is a concave surface and a second side surface thereof is a convex surface.

Table 10 shows basic parameters of the visual system according to the embodiment.

TABLE 10

| | | Surface | Radius of | Thickness/ | Refractive | Abbe | Refraction/ | Conic |
|---|---|---|---|---|---|---|---|---|
| Surface | Element | type | curvature | distance | index | number | Reflection | coefficient |
| S0 | | Spherical | Infinite | D1 | | | Refraction | |
| S1 | | Spherical | Infinite | 0.0000 | | | Refraction | |
| S2 | Diaphragm | Spherical | Infinite | 12.0000 | | | Refraction | |
| | (STO) | | | | | | | |
| S3 | First lens (E1) | Aspheric | 57.1120 | 4.7440 | 1.548 | 56.30 | Refraction | 1.6841 |
| S4 | Reflective | Spherical | Infinite | 0.1180 | 1.495 | 57.47 | Refraction | |
| | polarizing | | | | | | | |
| | element (RP) | | | | | | | |
| S5 | Quarter- | Spherical | Infinite | 0.1340 | 1.495 | 57.47 | Refraction | |
| | wave plate | | | | | | | |
| | (QWP) | | | | | | | |
| S6 | | Spherical | Infinite | D2 | | | Refraction | |
| S7 | Second lens | Aspheric | 1000.0000 | 6.0640 | 1.548 | 56.30 | Refraction | 99.0000 |
| | (E2) | | | | | | | |
| S8 | Partially- | Aspheric | −60.9233 | −6.0640 | 1.548 | 56.30 | Reflection | −3.0015 |
| | reflective | | | | | | | |
| | element (BS) | | | | | | | |
| S9 | | Aspheric | 1000.0000 | D3 | | | Refraction | 99.0000 |
| S10 | | Spherical | Infinite | −0.1340 | 1.495 | 57.47 | Refraction | |
| S11 | Reflective | Spherical | Infinite | 0.1340 | 1.495 | 57.47 | Reflection | |
| | polarizing | | | | | | | |
| | element (RP) | | | | | | | |
| S12 | | Spherical | Infinite | D4 | | | Refraction | |
| S13 | Second lens | Aspheric | 1000.0000 | 6.0640 | 1.548 | 56.30 | Refraction | 99.0000 |
| | (E2) | | | | | | | |
| S14 | Third lens (E3) | Aspheric | −60.9233 | 2.3181 | 1.548 | 56.30 | Refraction | −3.0015 |
| S15 | | Aspheric | −39.4172 | D5 | | | Refraction | −24.7771 |
| S16 | | Spherical | Infinite | 0.9000 | 1.519 | 64.17 | Refraction | |
| S17 | | Spherical | Infinite | 0.0000 | | | Refraction | |
| S18 | Image | Spherical | Infinite | 0.0000 | | | Refraction | |
| | surface (IMG) | | | | | | | |

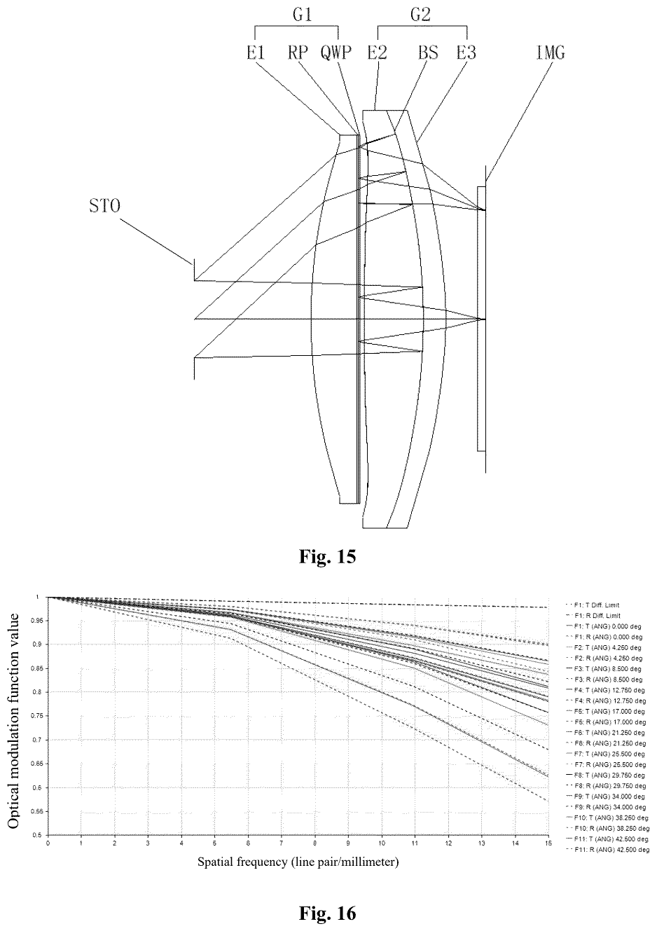

In the embodiment, a diaphragm STO is arranged on the first side of the visual system, and a display/an imaging surface IMG is arranged on the second side of the visual system. The first lens assembly G1: distances of the first lens E1, the reflective polarizing element RP, and the quarter-wave plate QWP from the display/the imaging surface IMG in an optical axis direction are relatively fixed. The second lens assembly G2: the second lens E2, the partially-reflective element BS, and the third lens E3 are able to move in the optical axis direction to close to or away from the display/the imaging surface IMG, and in this process, the visual system is able to zoom within a range from −5D to +2D. FIG. 13 shows a structural schematic diagram of the visual system when the second lens assembly G2 moves along the optical axis to a position closest to the display/the imaging surface IMG. In this case, the visual system is in a +2D state. FIG. 15 shows a structural schematic diagram of the visual system when the second lens assembly G2 moves along the optical axis to a position farthest away from the display/the imaging surface IMG. In this case, the visual system is in a −5D state.

When the visual system according to the embodiment is in the +2D state shown in FIG. 13 and the −5D state shown in FIG. 15, the values of the corresponding parameters D1 to D5 in Table 10 are shown in Table 11 below.

TABLE 11

| | D1 | D2 | D3 | D4 | D5 |
|---|---|---|---|---|---|
| +2D state | 500.0000 | 2.7219 | −2.7219 | 2.7219 | 1.0000 |
| −5D state | −200.0000 | 0.5006 | −0.5006 | 0.5006 | 3.2213 |

In the embodiment, the first side surface S3 of the first lens E1, the first side surface S13 of the second lens E2, a cemented surface S14 of the second lens E2 and the third lens E3, and the second side surface S15 of the third lens E3 are all aspheric surfaces. The surface types of various aspheric surfaces are calculated by using the formula (1) in Embodiment 1. Table 12 below provides higher-order term coefficients A4, A6, A8, A10, A12, A14, A16, A18, and A20 applied to each of the aspheric lenses S3 and S13-S15 in the embodiment.

TABLE 12

| | Surface | | | |
|---|---|---|---|---|
| Coefficient | S3 | S13 | S14 | S15 |
| A4 | −2.9247E−06 | 1.2102E−05 | 2.3863E−06 | 6.3263E−06 |
| A6 | 1.6227E−08 | −3.2768E−08 | −1.5857E−09 | −6.2153E−08 |
| A8 | −4.0928E−11 | −2.2534E−12 | −1.1040E−11 | 6.2266E−11 |
| A10 | 0.0000E+00 | 0.0000E+00 | 0.0000E+00 | 0.0000E+00 |
| A12 | 0.0000E+00 | 0.0000E+00 | 0.0000E+00 | 0.0000E+00 |
| A14 | 0.0000E+00 | 0.0000E+00 | 0.0000E+00 | 0.0000E+00 |
| A16 | 0.0000E+00 | 0.0000E+00 | 0.0000E+00 | 0.0000E+00 |
| A18 | 0.0000E+00 | 0.0000E+00 | 0.0000E+00 | 0.0000E+00 |
| A20 | 0.0000E+00 | 0.0000E+00 | 0.0000E+00 | 0.0000E+00 |

FIG. 14 shows an MTF curve of the visual system in the +2D state shown in FIG. 13 according to the embodiment. FIG. 16 shows an MTF curve of the visual system in the −5D state shown in FIG. 15 according to the embodiment. From FIG. 14 and FIG. 16, it is seen that, the visual system provided in the embodiment is able to achieve good imaging quality at two different focal lengths of +2D and −5D.

### Embodiment 5

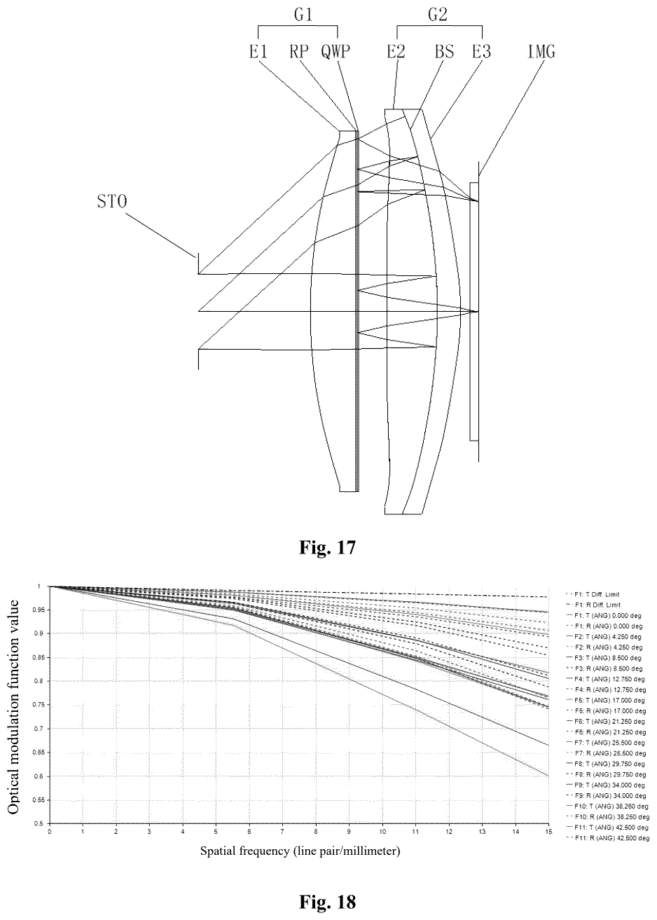

A visual system according to Embodiment 5 of the disclosure is described below with reference to FIGS. 17-20.

In the embodiment, the visual system sequentially includes from a first side to a second side along an optical axis: a first lens assembly G1 and a second lens assembly G2. The first lens assembly G1 includes a first lens E1, a reflective polarizing element RP, and a quarter-wave plate QWP, which are sequentially arranged from the first side to the second side along the optical axis. The reflective polarizing element RP is arranged on a second side surface of the first lens E1, and the quarter-wave plate QWP is arranged on a second side surface of the reflective polarizing element RP. The second lens assembly G2 includes a second lens E2, a partially-reflective element BS, and a third lens E3, which are sequentially arranged from the first side to the second side along the optical axis. The second lens E2 and the third lens E3 are cemented to each other. The partially-reflective element BS is arranged between the second lens E2 and the third lens E3.

In the embodiment, the first lens E1 has a positive refractive power, a first side surface thereof is a convex surface and a second side surface thereof is a planar surface; the second lens E2 has a positive refractive power, a first side surface thereof is a concave surface and a second side surface thereof is a convex surface; and the third lens E3 has a positive refractive power, a first side surface thereof is a concave surface and a second side surface thereof is a convex surface.

Table 13 shows basic parameters of the visual system according to the embodiment.

TABLE 13

| | | Surface | Radius of | Thickness/ | Refractive | Abbe | Refraction/ | Conic |
|---|---|---|---|---|---|---|---|---|
| Surface | Element | type | curvature | distance | index | number | Reflection | coefficient |
| S0 | | Spherical | Infinite | D1 | | | Refraction | |
| S1 | | Spherical | Infinite | 0.0000 | | | Refraction | |
| S2 | Diaphragm | Spherical | Infinite | 12.0000 | | | Refraction | |
| | (STO) | | | | | | | |
| S3 | First lens | Aspheric | 54.3119 | 4.8900 | 1.548 | 56.30 | Refraction | 0.3471 |
| | (E1) | | | | | | | |
| S4 | Reflective | Spherical | Infinite | 0.1180 | 1.495 | 57.47 | Refraction | |
| | polarizing | | | | | | | |
| | element (RP) | | | | | | | |
| S5 | Quarter- | Spherical | Infinite | 0.1340 | 1.495 | 57.47 | Refraction | |
| | wave plate | | | | | | | |
| | (QWP) | | | | | | | |
| S6 | | Spherical | Infinite | D2 | | | Refraction | |
| S7 | Second lens | Aspheric | −500.0000 | 5.4091 | 1.548 | 56.30 | Refraction | −99.0000 |
| | (E2) | | | | | | | |
| S8 | Partially- | Aspheric | −57.8869 | −5.4091 | 1.548 | 56.30 | Reflection | −2.3498 |
| | reflective | | | | | | | |
| | element (BS) | | | | | | | |
| S9 | | Aspheric | −500.0000 | D3 | | | Refraction | −99.0000 |
| S10 | | Spherical | Infinite | −0.1340 | 1.495 | 57.47 | Refraction | |
| S11 | Reflective | Spherical | Infinite | 0.1340 | 1.495 | 57.47 | Reflection | |
| | polarizing | | | | | | | |
| | element (RP) | | | | | | | |
| S12 | | Spherical | Infinite | D4 | | | Refraction | |
| S13 | Second lens | Aspheric | −500.0000 | 5.4091 | 1.548 | 56.30 | Refraction | −99.0000 |
| | (E2) | | | | | | | |
| S14 | Third lens | Aspheric | −57.8869 | 2.4892 | 1.548 | 56.30 | Refraction | −2.3498 |
| | (E3) | | | | | | | |
| S15 | | Aspheric | −27.8312 | D5 | | | Refraction | −10.2995 |
| S16 | | Spherical | Infinite | 0.9000 | 1.519 | 64.17 | Refraction | |
| S17 | | Spherical | Infinite | 0.0000 | | | Refraction | |
| S18 | Image | Spherical | Infinite | 0.0000 | | | Refraction | |
| | surface (IMG) | | | | | | | |

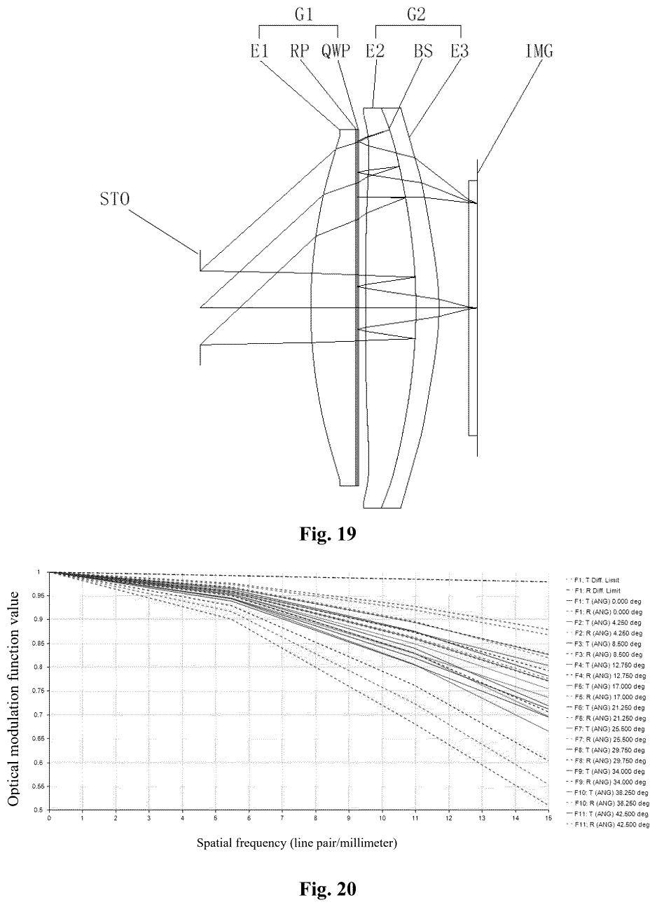

In the embodiment, a diaphragm STO is arranged on the first side of the visual system, and a display/an imaging surface IMG is arranged on the second side of the visual system. The first lens assembly G1: distances of the first lens E1, the reflective polarizing element RP, and the quarter-wave plate QWP from the display/the imaging surface IMG in an optical axis direction are relatively fixed. The second lens assembly G2: the second lens E2, the partially-reflective element BS, and the third lens E3 are able to move in the optical axis direction to close to or away from the display/the imaging surface IMG, and in this process, the visual system is able to zoom within a range from −5D to +2D. FIG. 17 shows a structural schematic diagram of the visual system when the second lens assembly G2 moves along the optical axis to a position closest to the display/the imaging surface IMG. In this case, the visual system is in a +2D state. FIG. 19 shows a structural schematic diagram of the visual system when the second lens assembly G2 moves along the optical axis to a position farthest away from the display/the imaging surface IMG. In this case, the visual system is in a −5D state.

When the visual system according to the embodiment is in the +2D state shown in FIG. 17 and the −5D state shown in FIG. 19, the values of the corresponding parameters D1 to D5 in Table 13 are shown in Table 14 below.

TABLE 14

| | D1 | D2 | D3 | D4 | D5 |
|---|---|---|---|---|---|
| +2D state | 500.0000 | 3.0597 | −3.0597 | 3.0597 | 1.0000 |
| −5D state | −200.0000 | 0.8400 | −0.8400 | 0.8400 | 3.2197 |

In the embodiment, the first side surface S3 of the first lens E1, the first side surface S13 of the second lens E2, a cemented surface S14 of the second lens E2 and the third lens E3, and the second side surface S15 of the third lens E3 are all aspheric surfaces. The surface types of various aspheric surfaces are calculated by using the formula (1) in Embodiment 1. Table 15 below provides higher-order term coefficients A4, A6, A8, A10, A12, A14, A16, A18, and A20 applied to each of the aspheric lenses S3 and S13-S15 in the embodiment.

TABLE 15

| | Surface | | | |
|---|---|---|---|---|
| Coefficient | S3 | S13 | S14 | S15 |
| A4 | −3.0146E−06 | 1.9696E−05 | 4.7944E−06 | 3.9629E−05 |
| A6 | 2.0191E−08 | −4.7456E−08 | −4.4489E−09 | −1.7519E−07 |
| A8 | −4.6596E−11 | 9.9562E−12 | −1.0327E−11 | 1.9510E−10 |
| A10 | 0.0000E+00 | 0.0000E+00 | 0.0000E+00 | 0.0000E+00 |
| A12 | 0.0000E+00 | 0.0000E+00 | 0.0000E+00 | 0.0000E+00 |
| A14 | 0.0000E+00 | 0.0000E+00 | 0.0000E+00 | 0.0000E+00 |
| A16 | 0.0000E+00 | 0.0000E+00 | 0.0000E+00 | 0.0000E+00 |
| A18 | 0.0000E+00 | 0.0000E+00 | 0.0000E+00 | 0.0000E+00 |
| A20 | 0.0000E+00 | 0.0000E+00 | 0.0000E+00 | 0.0000E+00 |

FIG. 18 shows an MTF curve of the visual system in the +2D state shown in FIG. 17 according to the embodiment. FIG. 20 shows an MTF curve of the visual system in the −5D state shown in FIG. 19 according to the embodiment. From FIG. 18 and FIG. 20, it is seen that, the visual system provided in the embodiment is able to achieve good imaging quality at two different focal lengths of +2D and −5D.

To sum up, in Embodiment 1 to Embodiment 5, the effective focal length fm of the visual system in the +2D state, the effective focal length fn of the visual system in the −5D state, the effective focal length f1 of the first lens, the effective focal length f2 of the second lens, the effective focal length f3 of the third lens, the combined focal length f23 of the second lens and the third lens, the combined focal length fz of the first lens, the reflective polarizing element, and the quarter-wave plate, the EPD of the visual system, the distance TDm from the first side surface of the first lens to the second side surface of the third lens on the optical axis when the visual system is in the +2D state, the distance TDn from the first side surface of the first lens to the second side surface of the third lens on the optical axis when the visual system is in the −5D state, the distance T12m from the second side surface of the first lens to the first side surface of the second lens on the optical axis when the visual system is in the +2D state, the distance T12n from the second side surface of the first lens to the first side surface of the second lens on the optical axis when the visual system is in the −5D state, the distance BFLm from the second side surface of the third lens to the display/the imaging surface on the optical axis when the visual system is in the +2D state, the distance BFLn from the second side surface of the third lens to the display/imaging surface on the optical axis when the visual system is in the −5D state, the distance ΔL of the second lens assembly moving along the optical axis during the switching of the visual system from the +2D state to the −5D state, and the change Δf in the effective focal length of the visual system switching from the +2D state to the −5D state are respectively shown in Table 16 below.

TABLE 16

| | Embodiment | | | | |
|---|---|---|---|---|---|
| | Embodi- | Embodi- | Embodi- | Embodi- | Embodi- |
| Parameter | ment 1 | ment 2 | ment 3 | ment 4 | ment 5 |
| fm (mm) | 17.42 | 17.42 | 17.49 | 17.41 | 17.41 |
| fn (mm) | 16.71 | 16.75 | 16.84 | 16.06 | 15.75 |
| f1 (mm) | 109.56 | 115.14 | 141.51 | 104.23 | 99.12 |
| f2 (mm) | 85.62 | 85.79 | 84.46 | 105.01 | 118.96 |
| f3 (mm) | −154.84 | −149.04 | −147.06 | 196.29 | 95.04 |
| f23 (mm) | 189.12 | 199.37 | 195.82 | 69.40 | 53.47 |
| fz (mm) | 109.56 | 115.14 | 141.51 | 104.23 | 99.12 |
| EPD (mm) | 8.00 | 8.00 | 8.00 | 8.00 | 8.00 |
| TDm (mm) | 16.10 | 16.10 | 15.14 | 16.10 | 16.10 |
| TDn (mm) | 13.87 | 13.89 | 12.79 | 13.88 | 13.88 |
| T12m (mm) | 3.00 | 2.96 | 3.10 | 2.97 | 3.31 |
| T12n (mm) | 0.77 | 0.75 | 0.75 | 0.75 | 1.09 |
| BFLm (mm) | 1.90 | 1.90 | 2.86 | 1.90 | 1.90 |
| BFLn (mm) | 4.13 | 4.11 | 5.21 | 4.12 | 4.12 |
| ΔL (mm) | 2.23 | 2.21 | 2.34 | 2.22 | 2.22 |
| Δf (mm) | 0.71 | 0.67 | 0.66 | 1.36 | 1.66 |

Furthermore, Embodiment 1 to Embodiment 5 respectively satisfy conditions shown in Table 17 below.

TABLE 17

| | Embodiment | | | | |
|---|---|---|---|---|---|
| Conditional expression | Embodiment 1 | Embodiment 2 | Embodiment 3 | Embodiment 4 | Embodiment 5 |
| fz/fm | 6.29 | 6.61 | 8.09 | 5.99 | 5.69 |
| f23/(TDm + TDn) | 6.31 | 6.65 | 7.01 | 2.32 | 1.78 |
| T12m/Δf | 4.24 | 4.43 | 4.70 | 2.19 | 2.00 |
| (CT2 + CT3)/ΔL | 3.78 | 3.93 | 3.56 | 3.77 | 3.56 |
| R1/fn | 3.59 | 3.77 | 4.52 | 3.56 | 3.45 |
| (CT1 + CTR + CTQ)/T12n | 6.41 | 6.27 | 5.26 | 6.64 | 4.71 |
| \|f2/f3\| × Δf (mm) | 0.39 | 0.38 | 0.38 | 0.73 | 2.08 |
| TDn/(f1/V1) | 7.13 | 6.79 | 5.04 | 7.50 | 7.88 |
| BFLn/T12n | 5.35 | 5.47 | 6.92 | 5.48 | 3.77 |
| CT3/BFLm | 1.27 | 1.41 | 1.09 | 1.22 | 1.31 |
| (f2/R4) × T12m (mm) | −3.75 | −3.74 | −3.78 | −5.13 | −6.81 |
| \|f3/R5\| × BFLm (mm) | 4.30 | 4.17 | 6.08 | 6.12 | 3.12 |
| fn/ΔL | 7.51 | 7.58 | 7.18 | 7.23 | 7.10 |
| EPD/Δf | 11.30 | 11.96 | 12.15 | 5.89 | 4.82 |
| (R1/R6) × ΔL (mm) | −0.37 | −0.34 | −0.36 | −3.22 | −4.33 |
| f23/(fm + fn) | 5.54 | 5.84 | 5.70 | 2.07 | 1.61 |
| \|f3\|/TDm | 9.62 | 9.26 | 9.71 | 12.19 | 5.90 |

The above descriptions are merely the specific embodiments and the used technical principles of the disclosure. It should be understood by those skilled in the art that the disclosed protection scope involved in the disclosure is not limited to the technical solution formed by a particular combination of the above technical features, but should also cover other technical solutions formed by any combination of the above technical features or their equivalent features without departing from the concept of the disclosure, for example, the technical solutions formed by interchanging the above features with (but not limited to) technical features with similar functions disclosed in the disclosure.

What is claimed is:

1. A visual system, sequentially comprising a first lens assembly and a second lens assembly from a first side to a second side along an optical axis, wherein
the first lens assembly comprises a first lens, a reflective polarizing element, and a quarter-wave plate, the first lens has a positive refractive power, a first side surface thereof is a convex surface and a second side surface thereof is a planar surface;
the second lens assembly comprises a second lens, a partially-reflective element, and a third lens, the second lens has a positive refractive power, a second side surface thereof is a convex surface; the third lens has a positive or negative refractive power, a first side surface thereof is a concave surface and a second side surface thereof is a convex surface; the second lens and the third lens form a cemented lens;
the second lens assembly is configured to be able to move along the optical axis to close to or far away from a display located on the second side, and to cause the visual system to switch between a first state and a second state; and
the visual system satisfies:
$$5.69 \leq fz / fm \leq 8.09 ;$$
$$1.78 \leq f 23 / ( TDm + TDn ) \leq 7 \text{.01} ;$$
$$2. \leq T 12 m / Δ f \leq 4. 70 ,$$
where fz is a combined focal length of the first lens, the reflective polarizing element, and the quarter-wave plate, fm is an effective focal length of the visual system in the first state, f23 is a combined focal length of the second lens and the third lens, TDm is a distance from the first side surface of the first lens to the second side surface of the third lens on the optical axis when the visual system is in the first state, TDn is a distance from the first side surface of the first lens to the second side surface of the third lens on the optical axis when the visual system is in the second state, T12m is a distance from the second side surface of the first lens to a first side surface of the second lens on the optical axis when the visual system is in the first state, and Δf is a change in the effective focal length of the visual system switching from the first state to the second state.

2. The visual system according to claim 1, wherein a center thickness CT2 of the second lens on the optical axis, a center thickness CT3 of the third lens on the optical axis, and a distance ΔL of the second lens assembly moving along the optical axis during a switching of the visual system from the first state to the second state satisfy:
$$3.55 < ( CT 2 + CT 3 ) / Δ L < 3.95 .$$

3. The visual system according to claim 1, wherein a radius of curvature R1 of the first side surface of the first lens and an effective focal length fn of the visual system in the second state satisfy:
$$3.45 \leq R 1 / fn \leq 4.52 .$$

4. The visual system according to claim 1, wherein a center thickness CT1 of the first lens on the optical axis, a center thickness CTR of the reflective polarizing element on the optical axis, a center thickness CTQ of the quarter-wave plate on the optical axis, and a distance T12n from the second side surface of the first lens to the first side surface of the second lens on the optical axis when the visual system is in the second state satisfy:
$$4.7 < ( CT 1 + CTR + CTQ ) / T 12 n < 6.65 .$$

5. The visual system according to claim 1, wherein an effective focal length f2 of the second lens, an effective focal length f3 of the third lens and the change Δf in the effective focal length of the visual system switching from the first state to the second state satisfy:
$$0.38 mm \leq \vert f 2 / f 3 \vert \times Δ f \leq 2.08 mm .$$

6. The visual system according to claim 1, wherein the distance TDn from the first side surface of the first lens to the second side surface of the third lens on the optical axis when the visual system is in the second state, an effective focal length f1 of the first lens and an Abbe number V1 of the first lens satisfy:
$$5. < TDn / ( f 1 / V 1 ) < 7.9 .$$

7. The visual system according to claim 1, wherein a distance BFLn from the second side surface of the third lens to the display on the optical axis when the visual system is in the second state and a distance T12n from the second side surface of the first lens to the first side surface of the second lens on the optical axis when the visual system is in the second state satisfy:
$$3.75 < BFLn / T 12 n < 6.95 .$$

8. The visual system according to claim 1, wherein a center thickness CT3 of the third lens on the optical axis and a distance BFLm from the second side surface of the third lens to the display on the optical axis when the visual system is in the first state satisfy:
$$1.05 < CT 3 / BFLm < 1.45 .$$

9. The visual system according to claim 1, wherein an effective focal length f2 of the second lens, a radius of curvature R4 of the second side surface of the second lens, and the distance T12m from the second side surface of the first lens to the first side surface of the second lens on the optical axis when the visual system is in the first state satisfy:
$$- 6 \text{.81} mm \leq ( f 2 / R 4 ) \times T 12 m \leq - 3 \text{.74} mm .$$

10. The visual system according to claim 1, wherein an effective focal length f3 of the third lens, a radius of curvature R5 of the first side surface of the third lens, and a distance BFLm from the second side surface of the third lens to the display on the optical axis when the visual system is in the first state satisfy:
$$3.12 mm \leq \vert f 3 / R 5 \vert \times BFLm \leq 6.12 mm .$$

11. The visual system according to claim 1, wherein an effective focal length fn of the visual system in the second state and a distance ΔL of the second lens assembly moving along the optical axis during a switching of the visual system from the first state to the second state satisfy:
$$7.1 \leq fn / Δ L \leq 7.58 .$$

12. The visual system according to claim 1, wherein an Entrance Pupil Diameter (EPD) of the visual system and the change Δf in the effective focal length of the visual system switching from the first state to the second state satisfy:
$$4.82 \leq EPD / Δ f \leq 12. 15 .$$

13. The visual system according to claim 1, wherein a radius of curvature R1 of the first side surface of the first lens, a radius of curvature R6 of the second side surface of the third lens, and a distance ΔL of the second lens assembly moving along the optical axis during a switching of the visual system from the first state to the second state satisfy:
$$- 4 \text{.33} mm \leq ( R 1 / R 6 ) \times Δ L \leq - 0 \text{.34} mm .$$

14. The visual system according to claim 1, wherein the combined focal length f23 of the second lens and the third lens, the effective focal length fm of the visual system in the first state, and an effective focal length fn of the visual system in the second state satisfy:
$$1. 61 \leq f 23 / ( fm + fn ) \leq 5.84 .$$

15. The visual system according to claim 1, wherein an effective focal length f3 of the third lens and the distance TDm from the first side surface of the first lens to the second side surface of the third lens on the optical axis when the visual system is in the first state satisfy:
$$5.9 \leq \vert f 3 \vert / TDm \leq 12.1 9 .$$
